(19) United States
(12) Patent Application Publication
(10) Pub. No.: US 2015/0172669 A1
(43) Pub. Date: Jun. 18, 2015

(54) SYSTEM AND METHOD FOR PROCESSING COMPRESSED IMAGES AND VIDEO FOR IMPROVED DATA COMMUNICATION

(71) Applicant: KASAH Technology, Inc., New York, NY (US)

(72) Inventors: Makoto NISHIYAMA, New York, NY (US); Kyonsoo HONG, New York, NY (US); Kazunobu TOGASHI, New York, NY (US); Noriharu YOSHIDA, San Diego, CA (US); Satomi YOSHIDA, San Diego, CA (US)

(21) Appl. No.: 14/570,580

(22) Filed: Dec. 15, 2014

Related U.S. Application Data
(60) Provisional application No. 61/916,036, filed on Dec. 13, 2013.

(51) Int. Cl. H04N 19/136; G06T 7/40; H04N 19/90; G06K 9/62; H04N 19/137; H04N 19/44; G06K 9/46

(52) U.S. Cl. CPC H04N 19/136; H04N 19/44; G06T 7/408; G06K 9/4604; G06K 9/6215; H04N 19/137; H04N 19/90

(57) ABSTRACT

Systems and methods of communicating image data over a communication network. The systems and methods include receiving, by a computing device, image data and compressing the image data, by the computing device, using at least one of a blurring function and a down sampling function to form a compressed image. The computing device can generate intensity data and edge data. The computing device can aggregate the compressed image data, the intensity data and the edge data into a single encoded file, and transmit by the computing device, the single encoded file over the communication network.

### CROSS-REFERENCES TO RELATED APPLICATIONS

This application claims priority under 35 U.S.C. 119(e) to U.S. Provisional Application No. 61/916,036, filed Dec. 13, 2014, entitled SYSTEM AND METHOD FOR PROCESSING COMPRESSED IMAGES AND VIDEO FOR IMPROVED DATA COMMUNICATION, the content of which is hereby incorporated herein in its entirety.

This application is related to U.S. patent application Ser. No. 13/834,790, filed on Mar. 15, 2013, entitled “SYSTEMS AND METHODS FOR PROVIDING IMPROVED DATA COMMUNICATION,” and International Application No.: PCT/2013/41299, entitled “SYSTEMS AND METHODS FOR PROVIDING IMPROVED DATA COMMUNICATION,” filed on May 16, 2013, both of which claims the benefit of U.S. Provisional Patent Application No. 61/648,774, entitled “SYSTEMS AND METHODS FOR MANAGING FILES WITH DIGITAL DATA,” filed on May 18, 2012; of U.S. Provisional Patent Application No. 61/675,193, entitled “SYSTEMS AND METHODS FOR MANAGING FILES WITH DIGITAL DATA,” filed on Jul. 24, 2012; and of U.S. Provisional Patent Application No. 61/723,032, entitled “SYSTEMS AND METHODS FOR MANAGING FILES WITH DIGITAL DATA,” filed on Nov. 6, 2012, the entire contents of all patent applications are herein incorporated by reference.

### BACKGROUND

1. Technical Field

Disclosed systems and methods relate in general to edge enhancement of compressed images and video, and to the creation and convolution of a compressible edge enhancement layer on a compressed images and video.

2. Description of the Related Art

Demand of and dependency on computer-operated devices is exponentially increasing on a global scale in both public and private sectors. For example, the popularity of social network platforms headlined by services such as Facebook and Twitter has significantly increased the usage of computer-operated devices, particularly fueling the increase in usage of mobile devices by the general consumer.

In one aspect, due to the increased usage of mobile devices, airwave spectrum availability for communication usage between mobile computer-operated devices has rapidly been consumed. It is projected that the airwave spectrum for internet and telecommunication use will be overloaded even with the government spectrum auction scheduled for 2015. This bandwidth shortage will ultimately limit the current freedom of web based communication as the current infrastructure will no longer be able to meet the demands of the population. In fact, more particularly, Internet and telecommunication providers and web based service providers are already encountering insufficient capacity to store the enormous amount of data in a memory that are required to maintain their services as the demand for high resolution imagery increases, especially on mobile platforms. To combat the insufficiency of the current infrastructure of computer networking systems and data storage, the information technology (IT) industry is faced with the inevitable choice of improving the current infrastructure by increasing data bandwidth and data storage capacities, reducing the stress on the infrastructure, or both.

Yet in another aspect, the full potential of computer-operated devices has not been fully exploited. One of the reasons is the lack of intuitive user interface. Some classes of consumers are still hindered from adopting new technologies and leveraging computer-operated devices because the user interface for operating the computer-operated devices is cumbersome, if not difficult to use. For example, the existing user interfaces do not allow a blind person to appreciate visual media, and they do not allow a hearing impaired person to appreciate audio media. Therefore, the IT industry is also faced with the task of improving user interfaces to accommodate a larger set of consumers.

In yet another aspect, methods of creating higher resolution and higher quality images and video that preserve edge information while maintaining quality of the overall picture have not been explored. One reason for this shortcoming is that prior method of utilizing an enhancement layer have resulted in large data sizes and inefficient pixel to bitrate ratios in video transfers across network systems, with enhanced images and video requiring drastically higher network bandwidth compared to the compressed base layer image or video. For example, the difference between the video bitrate of high quality SD 480p (640×480) video (15,000 kbps) and 1080p video (1920×1080) (50,000 kbps) on youtube is 35,000 kbps, with only (42.472-20.48) 21.992 pixels per kpbs savings with image quality enhancement. Similar pixel to video bitrate ratios are seen in live streaming video systems. According to manufacture specifications, standard video calling requires 128 kbps (320×240) upload while HD requires 1.2 mbps (1280×720) which is 1200 pixels per kpbs and 768 pixels per kpbs respectively. In this particular case the kbps to pixel count ratio decreases as image quality increases proving the enhancement layer contains greater data than the base bitstream. With such systems, compression of the base layer image or video provides a limited usability as inclusion of the enhancement layers will often negate the data saving benefits gained through compression. Also, current compression technologies utilizing blurring function and down-sampling techniques cannot be adequately decompressed to ensure edge detail.

### SUMMARY

Embodiments of the present invention address the challenges faced by the IT industry. One of the embodiments of the present invention includes a software application called the KasahComm application. The KasahComm application allows a user to interact with digital data in an effective and intuitive manner. Furthermore, the KasahComm application allows efficient communication between users using efficient data representations for data communication.

The disclosed subject matter includes a method of communicating by a computing device over a communication network. The method includes receiving, by a processor in the computing device, image data, applying, by the processor, a low-pass filter associated with a predetermined parameter on at least a portion of the image data to generate blurred image data, and compressing, by the processor, the blurred image data using an image compression system to generate compressed blurred image data. Furthermore, the method also includes sending, by the processor, the compressed blurred image data over the communication network, thereby consuming less data transmission capacity compared with sending the image data over the communication network.

The disclosed subject matter includes an apparatus for providing communication over a communication network. The apparatus can include a non-transitory memory storing computer readable instructions, and a processor in communication with the memory. The computer readable instructions are configured to cause the processor to receive image data, apply a low-pass filter associated with a predetermined parameter on at least a portion of the image data to generate blurred image data, compress the blurred image data using an image compression system to generate compressed blurred image data, and send the compressed blurred image data over the communication network, thereby consuming less data transmission capacity compared with sending the image data over the communication network.

The disclosed subject matter includes non-transitory computer readable medium. The computer readable medium includes computer readable instructions operable to cause an apparatus to receive image data, apply a low-pass filter associated with a predetermined parameter on at least a portion of the image data to generate blurred image data, compress the blurred image data using an image compression system to generate compressed blurred image data, and send the compressed blurred image data over the communication network, thereby consuming less data transmission capacity compared with sending the image data over the communication network.

The computer readable medium also includes computer readable instructions operable to create compressible, yet precise, enhancement layers with lower data sizes to enhance images and video compressed through blurring and down-sampling.

In one aspect, the image data includes data indicative of an original image and overlay layer information.

In one aspect, the overlay layer information is indicative of modifications made to the original image.

In one aspect, the method, the apparatus, or the non-transitory computer readable medium can include steps or executable instructions for applying the low-pass filter on the data indicative of original image.

In one aspect, the method, the apparatus, or the non-transitory computer readable medium can include steps or executable instructions for sending an image container over the communication network, where the image container includes the compressed blurred image data and the overlay layer information.

In one aspect, access to the original image is protected using a password, and the image container includes the password for accessing the original image.

In one aspect, the modifications made to the original image include a line overlaid on the original image.

In one aspect, the modifications made to the original image include a stamp overlaid on the original image.

In one aspect, the original image includes a map.

In one aspect, the low-pass filter includes a Gaussian filter and the predetermined parameter includes a standard deviation of the Gaussian filter.

The disclosed subject matter includes a method for sending an electronic message over a communication network using a computing device having a location service setting. The method can include identifying, by a processor in the computing device, an emergency contact to be contacted in an emergency situation, in response to the identification, overriding, by the processor, the location service setting of the computing device with a predetermined location service setting that enables the computing device to transmit location information of the computing device, and sending, by the processor, the electronic message, including the location information of the computing device, over the communication network.

The disclosed subject matter includes an apparatus for providing communication over a communication network. The apparatus can include a non-transitory memory storing computer readable instructions, and a processor in communication with the memory. The computer readable instructions are configured to identify an emergency contact to be contacted in an emergency situation, in response to the identification, override the location service setting of the computing device with a predetermined location service setting that enables the computing device to transmit location information of the computing device, and send the electronic message, including the location information of the computing device, over the communication network.

The disclosed subject matter includes non-transitory computer readable medium. The computer readable medium includes computer readable instructions operable to cause an apparatus to identify an emergency contact to be contacted in an emergency situation, in response to the identification, override the location service setting of the computing device with a predetermined location service setting that enables the computing device to transmit location information of the computing device, and send the electronic message, including the location information of the computing device, over the communication network.

In one aspect, the location information includes a Global Positioning System coordinate.

The disclosed subject matter includes a method for visualizing audio information using a computer system. The method includes determining, by a processor in the computer system, a pitch profile of the audio information, where the pitch profile includes a plurality of audio frames, identifying, by the processor, an audio frame type associated with one of the plurality of audio frames, determining, by the processor, an image associated with the audio frame type of the one of the plurality of audio frames, and displaying the image on a display device coupled to the processor.

The disclosed subject matter includes an apparatus for visualizing audio information. The apparatus can include a non-transitory memory storing computer readable instructions, and a processor in communication with the memory. The computer readable instructions are configured to determine a pitch profile of the audio information, wherein the pitch profile includes a plurality of audio frames, identify an audio frame type associated with one of the plurality of audio frames, determine an image associated with the audio frame type associated with one of the plurality of audio frames, and display the image on a display coupled to the processor.

The disclosed subject matter includes non-transitory computer readable medium. The computer readable medium includes computer readable instructions operable to cause an apparatus to determine a pitch profile of the audio information, wherein the pitch profile includes a plurality of audio frames, identify an audio frame type associated with one of the plurality of audio frames, determine an image associated with the audio frame type associated with one of the plurality of audio frames, and display the image on a display coupled to the processor.

In one aspect, the method, the apparatus, or the non-transitory computer readable medium can include steps or executable instructions for measuring changes in pitch levels within the one of the plurality of audio frames.

In one aspect, the method, the apparatus, or the non-transitory computer readable medium can include steps or executable instructions for measuring: (1) a rate at which the pitch levels change, (2) an amplitude of the pitch levels, (3) a frequency content of the pitch levels, (4) wavelet spectral information of the pitch levels, and (5) a spectral power of the pitch levels.

In one aspect, the method, the apparatus, or the non-transitory computer readable medium can include steps or executable instructions for identifying one or more repeating sound patterns in the plurality of audio frames.

In one aspect, the method, the apparatus, or the non-transitory computer readable medium can include steps or executable instructions for comparing pitch levels within the one of the plurality of audio frames to pitch levels associated with different sound sources.

In one aspect, the pitch levels associated with different sound sources are maintained as a plurality of audio fingerprints in an audio database.

In one aspect, the method, the apparatus, or the non-transitory computer readable medium can include steps or executable instructions for comparing characteristics of the one of the plurality of audio frames with those of the plurality of audio fingerprints.

In one aspect, an audio fingerprint can be based on one or more of: (1) average zero crossing rates associated with the pitch levels of the one of the plurality of audio frames, (2) tempo associated with the pitch levels of the one of the plurality of audio frames, (3) average spectrum associated with the pitch levels of the one of the plurality of audio frames, (4) a spectral flatness associated with the pitch levels of the one of the plurality of audio frames, (5) prominent tones across a set of bands and bandwidth associated with the pitch levels of the one of the plurality of audio frames, and (6) coefficients of encoded pitch levels of the one of the plurality of audio frames.

In one aspect, systems and methods of communicating image data over a communication network are disclosed. In one aspect, the systems and methods can include receiving, by a computing device, image data. In one aspect, the systems and methods can include compressing the image data, by the computing device, using at least one of a blurring function and a down sampling function to form a compressed image. In one aspect, the systems and methods can include generating, by the computing device, intensity data, the intensity data comprising differences in intensity between adjacent pixels in the image data. In one aspect, the systems and methods can include generating, by the computing device, edge data, the edge data comprising a bitmap including data corresponding to edge information of the image data. In one aspect, the systems and methods can include aggregating, by the computing device, the compressed image data, the intensity data and the edge data into a single encoded file; and transmitting, by the computing device, the single encoded file over the communication network.

In one aspect, the intensity data comprises at least three intensity data sets.

In one aspect, systems and methods of communicating images over a communication network further comprise generating, by the computing device, a first intensity data set based on a portion of pixels of the compressed image; generating, by the computing device, a second intensity data set, wherein the method of generating the second intensity data set comprises: decompressing, by the computing device, the compressed image data to form decompressed image data; and extracting, by the computing device, a luminescence in a color space from the decompressed image; and generating, by the computing device, a third intensity data set based on a portion of pixels of the image data.

In one aspect, the image comprises a digital image. In one aspect, the image comprises a single frame from video data. In one aspect, the luminescence comprises a Y component and the color space comprises a YCbCr space.

In one aspect, an apparatus is disclosed for communicating image data over a communication network. In some aspects, the apparatus comprises memory containing instructions for execution by a processor, the processor configured to receive image data. In one aspect, the processor is configured to compress the image data using at least one of a blurring function and a down sampling function to form a compressed image. In one aspect, the processor is configured to generate intensity data, the intensity data comprising differences in intensity between adjacent pixels in the image data. In one aspect, the processor is configured to generate edge data, the edge data comprising a bitmap including data corresponding to edge information of the image data. In one aspect, the processor is configured to aggregate the compressed image data, the intensity data and the edge data into a single encoded file; and transmit the single encoded file over the communication network.

In one aspect, systems and methods are disclosed for communicating image data over a communication network. In one aspect, the systems and methods include receiving, by a computing device, image data; identifying, by the computing device, at least one similarity macroblock in the image data, the at least one similarity macroblock having a level of similarity to at least one macroblock in reference image data. In one aspect, the systems and methods include identifying, by the computing device, difference data, the difference data comprising at least one macroblock in the image data having a level of difference from at least one macroblock in the reference image data. In one aspect, the systems and methods include generating, by the computing device, at least one motion vector corresponding to the reference image data, the at least one motion vector allowing for at least one of motion estimation and motion compensation between the at least one similarity macroblock in the image data and the at least one macroblock in the reference image data. In one aspect, the systems and methods include aggregating, by the computing device, the image data, the difference data, and the at least one motion vector into a single file. In one aspect, the systems and methods include compressing, by the computing device, the single file to form a single encoded file. In one aspect, the systems and methods include transmitting, by the computing device, the single encoded file over the communication network.

In one aspect, systems and methods for determining the at least one similarity macroblock comprises processing the image data using at least one block matching algorithm. In some aspects, the at least one similarity macroblock comprises at least one of the image data, a subset of the image data, and a single pixel of the image data. In some aspects, the subset of the image data comprises at least one of pixels forming at least one rectangular block and pixels forming at least one arbitrarily shaped patch. In some aspects, creating the at least one motion vector corresponding to the at least one reference image data further comprises creating, by the computing device, multiple motion vectors corresponding to data in multiple reference images, the multiple motion vectors allowing for at least one of motion estimation and motion compensation between the multiple macroblocks in the image data and the multiple macroblocks in the data corresponding to the multiple reference images.

In one aspect, an apparatus is disclosed for communicating image data over a communication network. In some aspects, the apparatus comprises memory containing instructions for execution by a processor, the processor configured to receive image data. In one aspect, the processor is configured to identify at least one similarity macroblock in the image data, the at least one similarity macroblock having a level of similarity to at least one macroblock in reference image data In one aspect, the processor is configured to identify difference data, the difference data comprising at least one macroblock in the image data having a level of difference from at least one macroblock in the reference image data. In one aspect, the processor is configured to generate at least one motion vector corresponding to the reference image data, the at least one motion vector allowing for at least one of motion estimation and motion compensation between the at least one similarity macroblock in the image data and the at least one macroblock in the reference image data. In one aspect, the processor is configured to aggregate the image data, the difference data, and the at least one motion vector into a single file. In one aspect, the processor is configured to compress the single file to form a single encoded file In one aspect, the processor is configured to transmit the single encoded file over the communication network.

In one aspect, the method, the apparatus, or the non-transitory computer readable medium can include steps or executable instructions for retrieving, from a non-transitory computer readable medium, an association between the audio frame type and the image.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, captured in conjunction with the accompanying drawings. Understanding that these drawings depict only several embodiments in accordance with the disclosure and are, therefore, not to be considered limiting in its scope, the disclosure will be described with additional specificity and detail through use of the accompanying drawings.

FIG. 1 illustrates a diagram of a networked communication arrangement in accordance with embodiments of the present invention.

FIG. 2A illustrates an introduction screen in accordance with embodiments of the present invention.

FIG. 2B illustrates a registration interface in accordance with embodiments of the present invention.

FIG. 3A illustrates a contact interface in accordance with embodiments of the present invention.

FIG. 3B illustrates a “Add a New Contact” interface in accordance with embodiments of the present invention.

FIG. 3C illustrates a “Choose Contacts” interface in accordance with embodiments of the present invention.

FIG. 4 illustrates a recipient's “Contacts” interface in accordance with embodiments of the present invention.

FIG. 5 illustrates a specialized contact list of the KasahComm application in accordance with embodiments of the present invention.

FIG. 6 illustrates a user interface when the user receives a new message in accordance with embodiments of the present invention.

FIG. 7 illustrates interaction mechanisms for users in accordance with embodiments of the present invention.

FIG. 8 further illustrates interaction mechanisms for users in accordance with embodiments of the present invention.

FIG. 9 illustrates an album interface as displayed on a screen in accordance with embodiments of the present invention.

FIG. 10 illustrates a list of the photos sent/captured associated with a user in accordance with embodiments of the present invention.

FIG. 11 illustrates a setting interface in accordance with embodiments of the present invention.

FIG. 12 illustrates a user interface for a photo communication in accordance with embodiments of the present invention.

FIG. 13 illustrates a photo capture interface illustrated on a screen in accordance with embodiments of the present invention.

FIG. 14 illustrates a photo editing interface illustrated on a screen in accordance with embodiments of the present invention.

FIG. 15 illustrates a use of a color selection interface in accordance with embodiments of the present invention.

FIG. 16 illustrates the use of the stamp interface in accordance with embodiments of the present invention.

FIG. 17 illustrates the example of a photo editing interface in accordance with embodiments of the present invention.

FIG. 18 illustrates a process of providing an efficient representation of images in accordance with embodiments of the present invention.

FIG. 19A is a diagram of an image container for a single compressed file in accordance with embodiments of the present invention.

FIG. 19B is a diagram of an image container for more than one compressed files in accordance with embodiments of the present invention.

FIG. 19C is a diagram of an image container for a single compressed file and its associated overlay layer in accordance with embodiments of the present invention.

FIG. 19D is a diagram of an image container for more than one compressed files and their associated overlay layer in accordance with embodiments of the present invention.

FIG. 20 illustrates an image recovery procedure in accordance with embodiments of the present invention.

FIGS. 21A-21C illustrate a demonstration of an image recovery procedure in accordance with embodiments of the present invention.

FIG. 22 illustrates an interface for replying to a received photograph in accordance with embodiments of the present invention.

FIG. 23 illustrates a keyboard text entry function in accordance with embodiments of the present invention.

FIG. 24 illustrates how the KasahComm application uses location information associated with a photograph to provide local location and local weather forecast services in accordance with embodiments of the present invention.

FIG. 25 illustrates an edited map in accordance with embodiments of the present invention.

FIGS. 26A-26E illustrate a process of generating a multi-layer image data file in accordance with embodiments of the present invention.

FIG. 27 shows a flow chart for generating a visual representation of audio information in accordance with embodiments of the present invention.

FIGS. 28A-28D illustrate a process of generating a visual representation of audio information in accordance with embodiments of the present invention.

FIGS. 29A-29D illustrate a process of isolating sound patterns from audio information in accordance with embodiments of the present invention.

FIGS. 30A-30C illustrate an image representation that includes both an image file and a password in accordance with embodiments of the present invention.

FIG. 31 illustrates encoding and decoding of an input image or video frame in accordance with embodiments of the present invention.

FIG. 32 illustrates a process of creating an edge enhancement layer in accordance with embodiments of the present invention.

FIG. 33 illustrates a process of extracting color information from bitmap edge data in accordance with embodiments of the present invention.

FIG. 34 illustrates measuring the color difference metric between pixels in accordance with embodiments of the present invention.

FIG. 35 illustrates a mapping of original spatial intensity metric data to values with lower bit depth in accordance with embodiments of the present invention.

FIG. 36 illustrates reprocessing of edge information in accordance with embodiments of the present invention.

FIG. 37 illustrates a process of creating a file containing a lower bit depth enhancement layer and a compressed image, in accordance with some embodiments.

FIG. 38 illustrates a process of utilizing enhancement layers to enhance edge information in a decompressed image, in accordance with some embodiments.

FIG. 39 illustrates a process of utilizing resource images to determine difference data in an original image, in accordance with some embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Embodiments of the present inventions include a software application called the KasahComm application. The KasahComm application is a communication program including executable instructions that enable network communication between computing devices. The KasahComm application can enable computing devices to efficiently transmit and receive digital data, including image data and text data, over a communication network. The KasahComm application also enables users of the computing devices to intuitively interact with digital data.

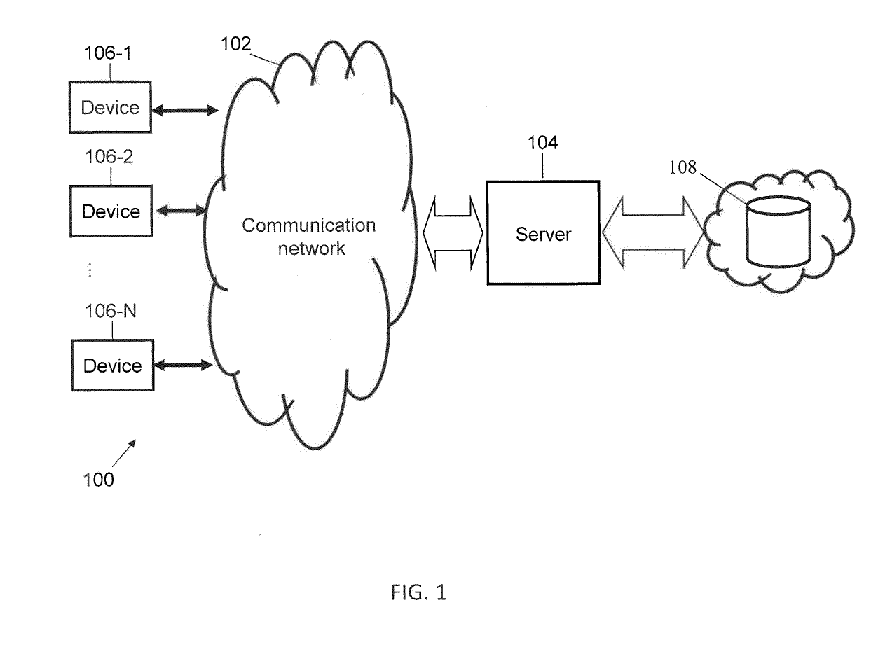

FIG. 1 illustrates a diagram of a networked communication arrangement in accordance with an embodiment of the disclosed subject matter. The networked communication arrangement 100 can include a communication network 102, a server 104, and at least one computing device 106 (e.g., computing device 106-1, 106-2, . . . 106-N), and a storage system 108.

The computing devices 106 can include non-transitory computer readable medium that includes executable instructions operable to cause the computing device 106 to run the KasahComm application. The KasahComm application can allow the computing devices 106 to communicate over the communication network 102. A computing device 106 can include a desktop computer, a mobile computer, a tablet computer, a cellular device, or any computing systems that is capable of performing computation. The computing device 106 can be configured with one or more processors that process instructions and run instructions that may be stored in non-transitory computer readable medium. The processor also communicates with the non-transitory computer readable medium and interfaces to communicate with other devices. The processor can be any applicable processor such as a system-on-a-chip that combines a central processing unit (CPU), an application processor, and flash memory.

The server 104 can be a single server, or a network of servers, or a farm of servers in a data center. Each computing device 106 can be directly coupled to the server 104; alternatively, each computing device 106 can be connected to server 104 via any other suitable device, communication network, or combination thereof. For example, each computing device 106 can be coupled to the server 104 via one or more routers, switches, access points, and/or communication networks (as described below in connection with communication network 102).

Each computing device 106 can send data to, and receive data from, other computing devices 106 over the communication network 102. Each computing device 106 can also send data to, and receive data from, the server 104 over the communication network 102. Each computing device 106 can send data to, and receive data from, other computing devices 106 via the server 104. In such configurations, the server 104 can operate as a proxy server that relays messages between the computing devices.

The communication network 102 can include a network or combination of networks that can accommodate data communication. For example, the communication network can include a local area network (LAN), a virtual private network (VPN) coupled to the LAN, a private cellular network, a private telephone network, a private computer network, a private packet switching network, a private line switching network, a private wide area network (WAN), a corporate network, a public cellular network, a public telephone network, a public computer network, a public packet switching network, a public line switching network, a public wide area network (WAN), or any other types of networks implementing one of a variety of communication protocols, including Global System for Mobile communication (GSM), Universal Mobile Telecommunications System (UMTS), Long Term Evolution (LTE), and/or IEEE 802.11. Such networks may be implemented with any number of hardware and software components, transmission media and network protocols. FIG. 1 shows the network 102 as a single network; however, the network 102 can include multiple interconnected networks listed above.

For the purpose of discussion, the foregoing figures illustrate how the disclosed subject matters are embodied in the KasahComm application. However, the disclosed subject matters can be implemented as standalone software applications that are independent of the KasahComm application.

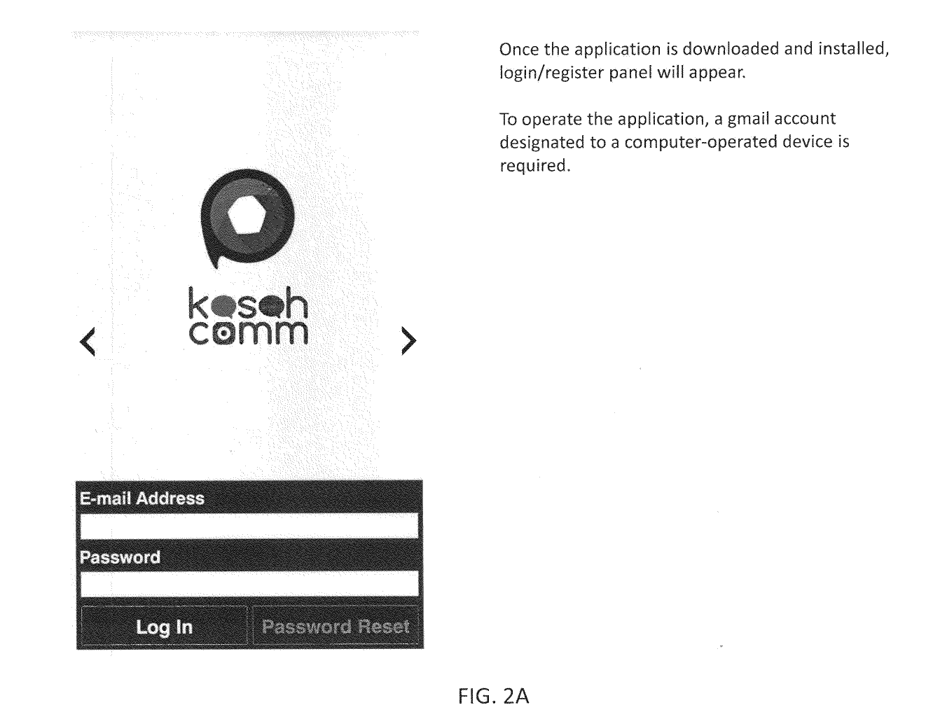

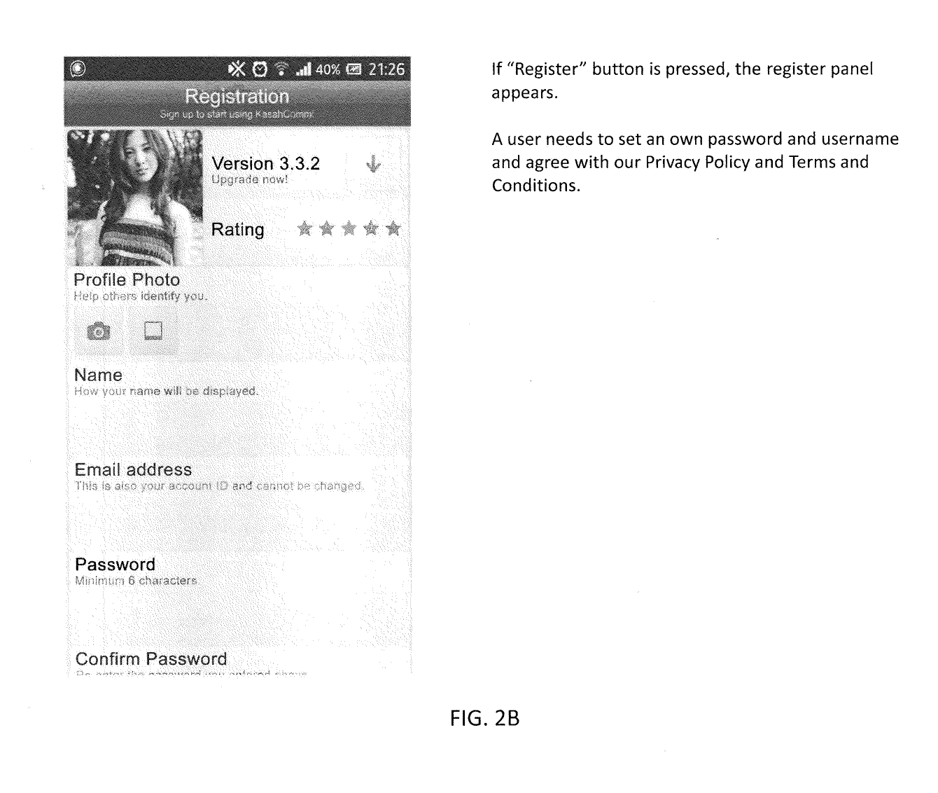

FIG. 2A illustrates an introduction interface of the KasahComm application in accordance with embodiments of the present invention. Once the KasahComm application is downloaded and installed, the login/register interface can appear. If the user is already registered to use the KasahComm application, the user can provide the registered email account and the password and click on the “Login” button. If the user is not already registered to use the KasahComm application, the user can click on the “Register” button.

In embodiments, if the user clicks on the “Register” button, the KasahComm application can provide a registration interface. FIG. 2B illustrates a registration interface of the KasahComm application in accordance with embodiments of the present invention. Using the registration interface, the user can set the user's own username and password, and agree with the KasahComm application's Privacy Policy and Terms and Conditions.

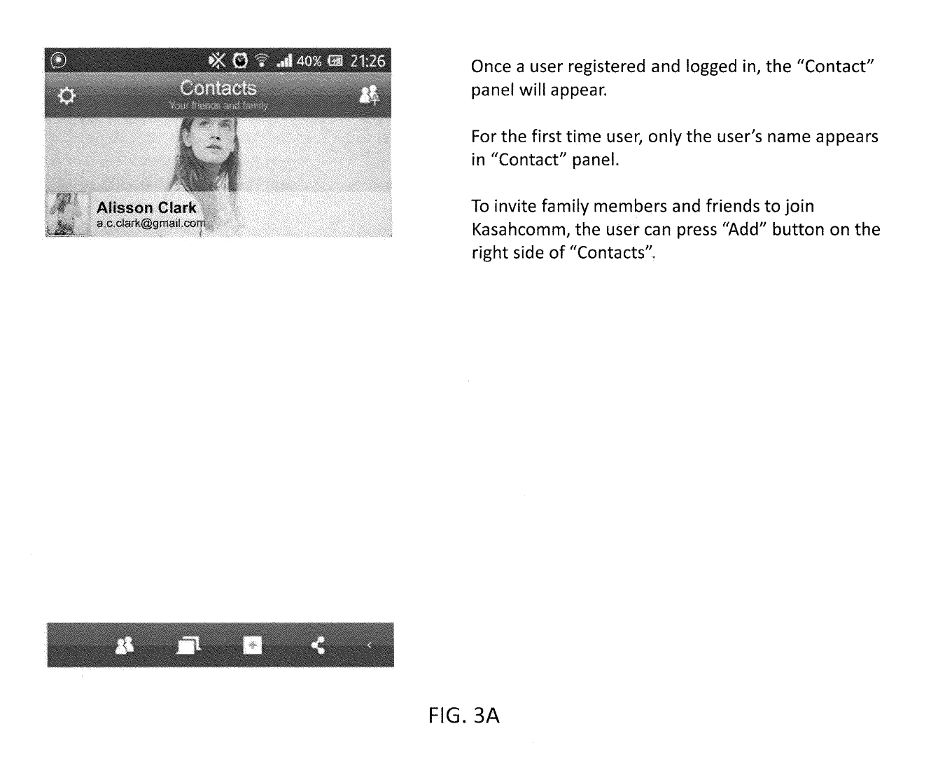

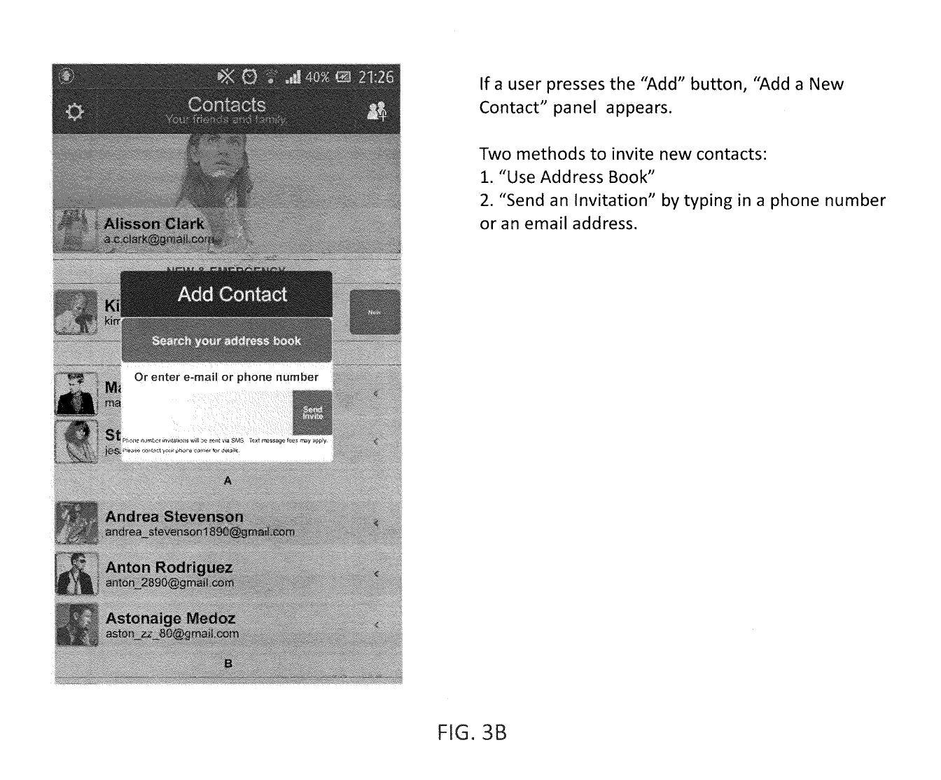

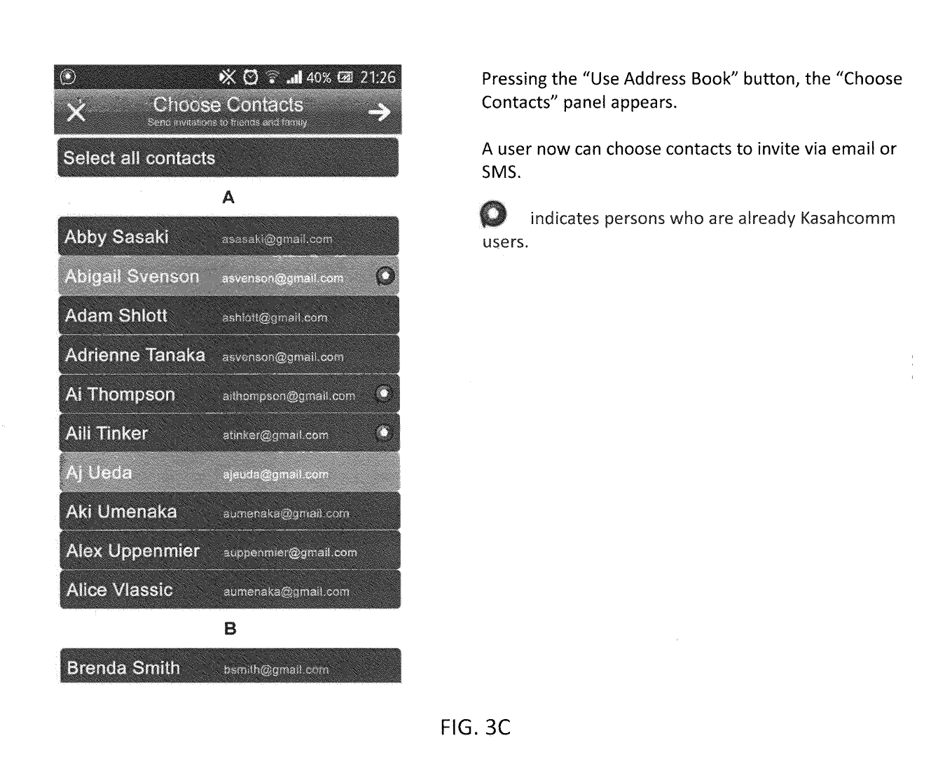

Once the user is registered and logged in, the KasahComm application can provide the contact interface. FIG. 3A illustrates a contact interface of the KasahComm application in accordance with embodiments of the present invention. If the user is using the KasahComm application for the first time, the contact interface can provide only the user's name. To invite family members and friends to join KasahComm application, the user can press “Add” button on the right side of “Contacts”.

If a user presses the “Add” button, the KasahComm application can provide the “Add a New Contact” interface. FIG. 3B illustrates the “Add a New Contact” interface of the KasahComm application in accordance with embodiments of the present invention. The “Add a New Contact” interface can provide at least two different mechanisms for adding new contacts. In the first mechanism, the “Add a New Contact” interface can automatically add contacts. To do so, the “Add a New Contact” interface can use an address book to identify people that the user may be interested in contacting. Then the “Add a New Contact” interface can send invitations to the identified people. In the second mechanism, the “Add a New Contact” interface can request the user to manually input the information of the person to be added. The information can include a phone number or an email address.

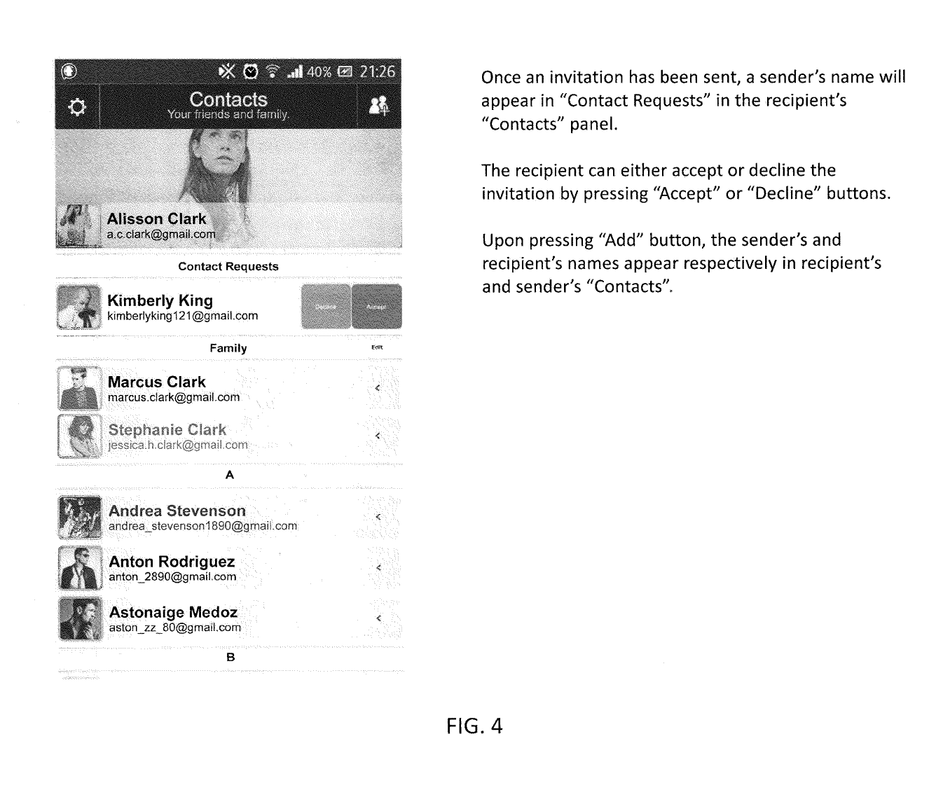

To use the first mechanism for adding new contacts, the user can press the “Use Address Book” button. When the user presses the “Use Address Book” button, the KasahComm application can provide the “Choose Contacts” interface. FIG. 3C illustrates a “Choose Contacts” interface of the KasahComm application in accordance with embodiments. The user can use the “Choose Contacts” interface to add new contacts. In embodiments, the “Choose Contacts” interface can indicate which of the people in the address book are already registered to use the KasahComm application. If the user clicks on any one of the contacts in the address book, the KasahComm application can use the email or a short message service (SMS) to invite the selected person. Once the KasahComm application sends the invitation, the sender's name can appear in “Pending Contact Requests” in the recipient's “Contacts” interface. FIG. 4 illustrates a “Contacts” interface of the KasahComm application in accordance with embodiments of the present invention. The recipient can then either accept or decline the invitation by pressing “Accept” or “Decline” buttons. Upon pressing “Accept” button, the sender's and recipient's names appear respectively in recipient's and sender's “Contacts”.

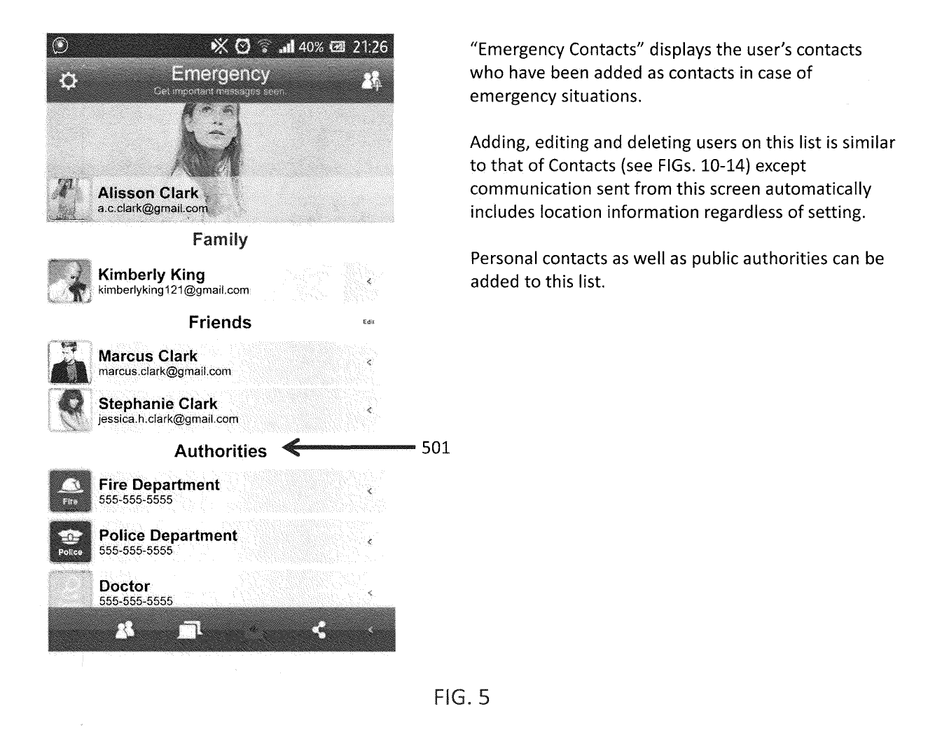

In embodiments, the KasahComm application can include a specialized contact list. The specialized contact list can include “Emergency Contacts.” FIG. 5 illustrates a specialized contact list of the KasahComm application in accordance with embodiments of the present invention. The functionality of the specialized contact list can be similar to that of the “Contacts” interface. However, in addition to personal contacts, “Emergency Contacts” can include an “Authorities” contact category 501 that includes contacts to agencies dealing with emergency situations. The agencies dealing with emergency situations can include fire departments, police departments, ambulance services, and doctors and hospitals. All communication originating from “Emergency Contacts” will include location information regardless of the user's preferences in “Settings.”

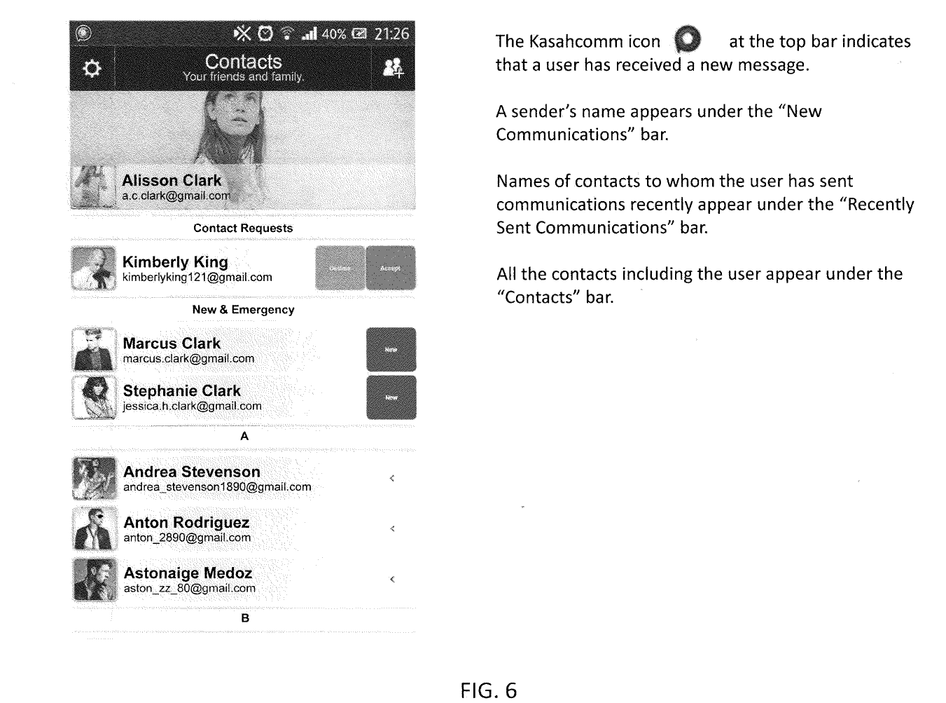

In embodiments, the KasahComm application can indicate that the user has received a new message via the KasahComm application. For example, the top notification bar can provide the KasahComm application logo. FIG. 6 illustrates a user interface when the user receives a new message in the KasahComm application in accordance with embodiments of the present invention. If the user receives a message, the sender of the message can appear under the “New Communications” bar. In embodiments, all the contacts including the user can appear under the “Contacts” bar. In embodiments, recent communications can appear as an integrated or separate list that can include both photos and text based messages.

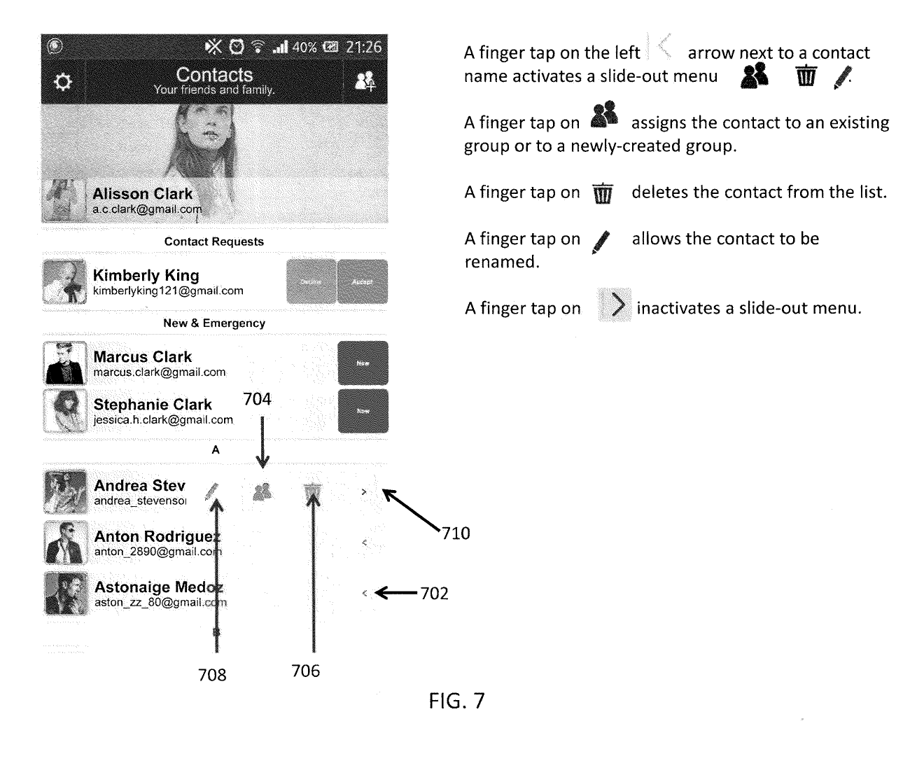

In embodiments, the KasahComm application can provide the user different mechanisms to interact with the KasahComm application. FIG. 7 illustrates interaction mechanisms for users of the KasahComm application in accordance with embodiments. The left arrow 702 can be linked to a slide-out menu. When a user selects the left arrow 702 next to a contact name, the KasahComm application can provide a slide-out menu. The slide-out menu can include a group icon 704, a trash can icon 706, a pencil icon 708, and a right arrow 710. When a user selects the group icon 704, the KasahComm application can add the associated contact to an existing group or a newly created group. When a user selects the trash can icon 706, the KasahComm application can delete the associated contact. When a user selects the pencil icon 708, the KasahComm application can rename the associated contact. When a user selects the right arrow 710, the KasahComm application can deactivate the slide-out menu.

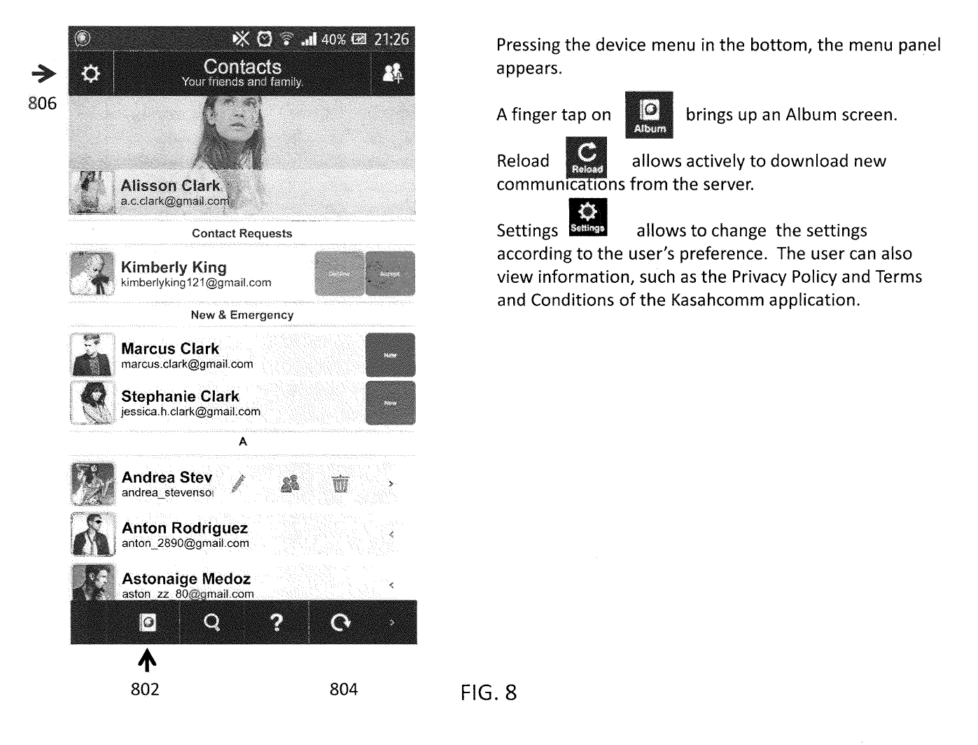

FIG. 8 further illustrates interaction mechanisms for users of the KasahComm application in accordance with embodiments. When the user presses the device menu at the bottom, the KasahComm application can provide a menu interface. If the user selects the album button 802, the KasahComm application can provide the album screen. FIG. 9 illustrates an album interface of the KasahComm application in accordance with embodiments of the present invention. Albums are displayed in folders assigned to each contact, including one for the user. When a user selects a folder, the KasahComm application can provide the list of the photos sent/captured according to date and time by the contact associated with the folder.

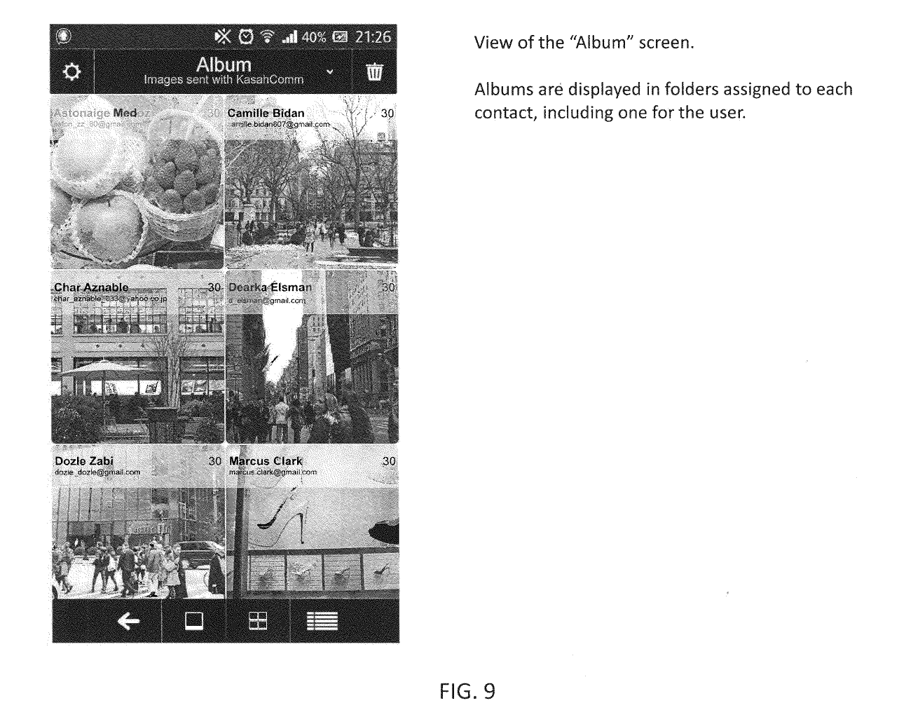

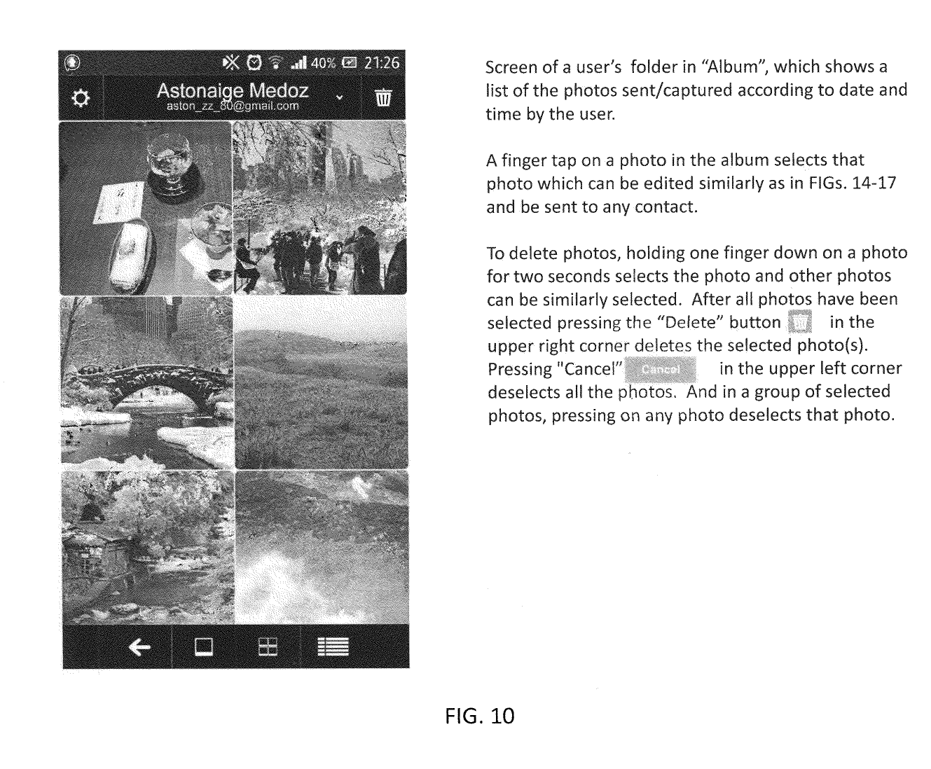

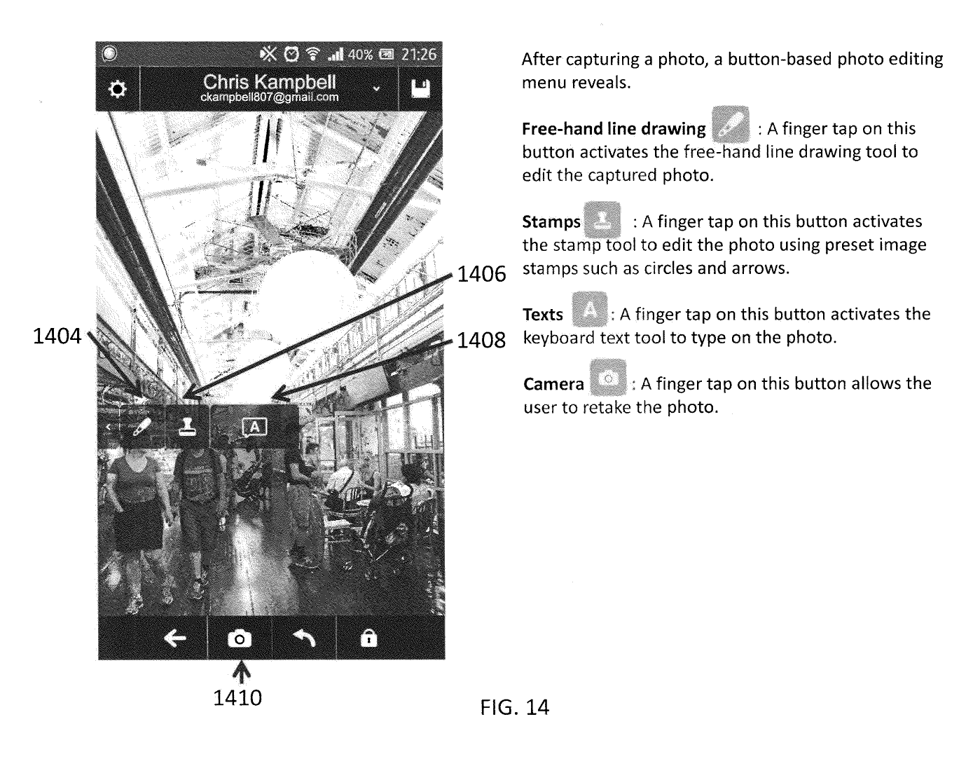

FIG. 10 illustrates a list of the photos sent/captured according to date and time in the KasahComm application in accordance with embodiments of the present invention. A finger select on a photo in the album selects that photo which can be edited and be sent to any contact. Before the selected photo(s) are sent to other contacts, the KasahComm application processes the photo(s) in accordance with FIGS. 14-17. To delete photos, holding one finger down on a photo for two seconds selects the photo and other photos can be similarly selected. After all photos have been selected pressing the “Delete” button in the upper right corner deletes the selected photo(s). Pressing “Cancel” in the upper left corner deselects all the photos. And in a group of selected photos, pressing on any photo deselects that photo.

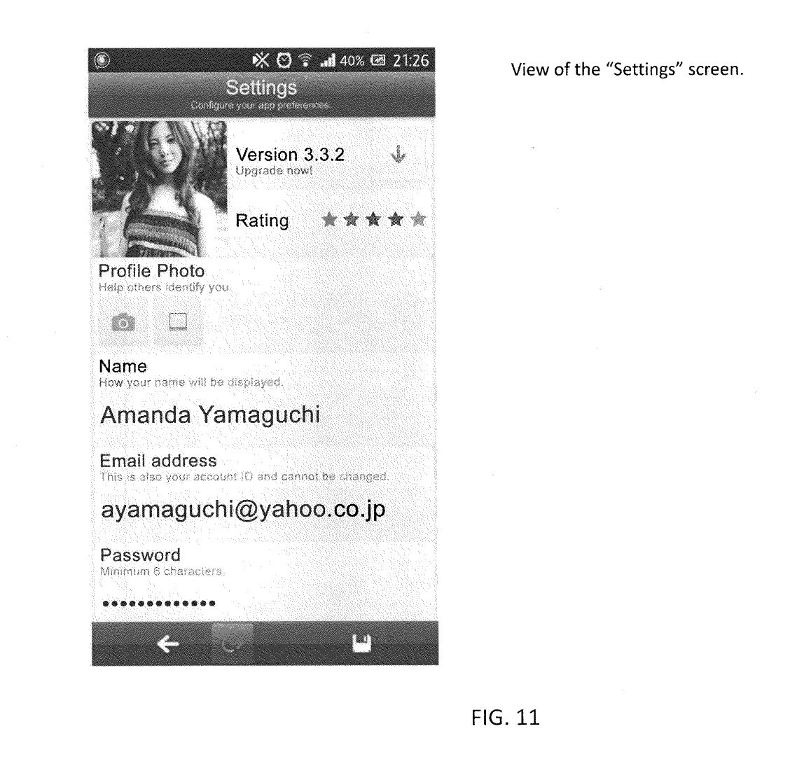

Referring to FIG. 8 again, if the user clicks selects the reload button 804, the KasahComm application can download new communications from the server. If the user selects the settings button 806, the KasahComm application can provide a setting interface. The setting interface can allow the user to change the settings according to the user's preference. The user can also view information, such as the Privacy Policy and Terms and Conditions of the KasahComm application. FIG. 11 illustrates a setting interface of the KasahComm application in accordance with embodiments.

FIG. 12 illustrates a user interface for taking pictures in the KasahComm application in accordance with embodiments of the present invention. When a user clicks on a contact person, the KasahComm application opens all communications with the selected contact. The Take Photo icon on the right side of the top menu bar activates the photo capture screen. The Message icon 1202 activates text based messaging input within the KasahComm application. The Load icon 1204 allows the user to send a photo from his/her photo gallery to the selected contact. The Map icon 1206 allows the user to open a map with their current location that can be edited and sent to the selected contact. The Reload icon 1208 allows the user to refresh the communication screen to view any new messages that have not been transferred to the device.

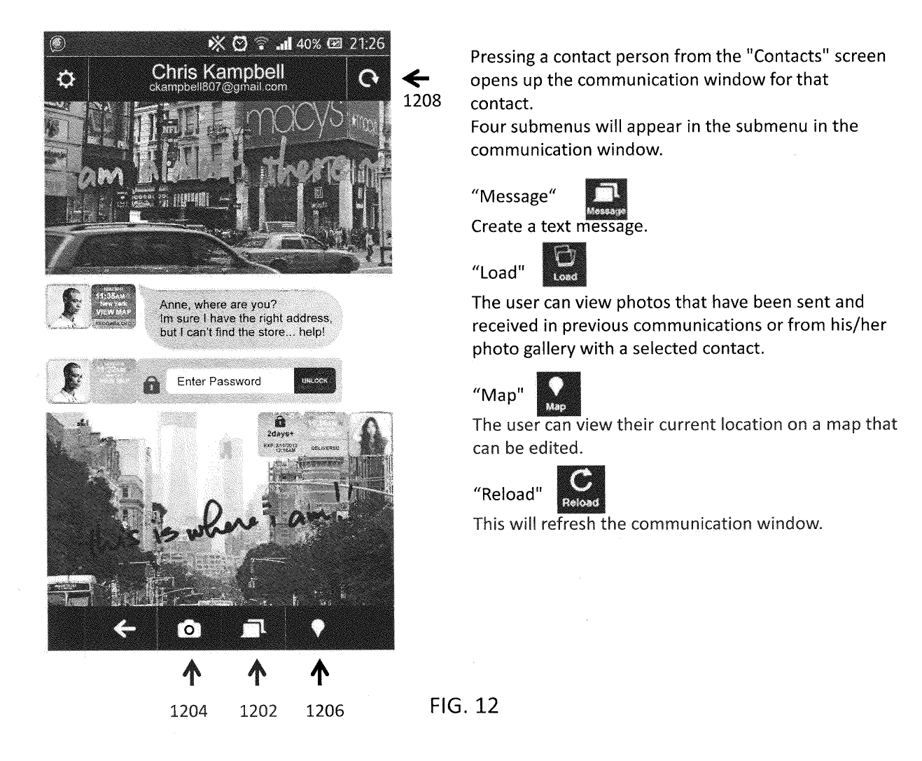

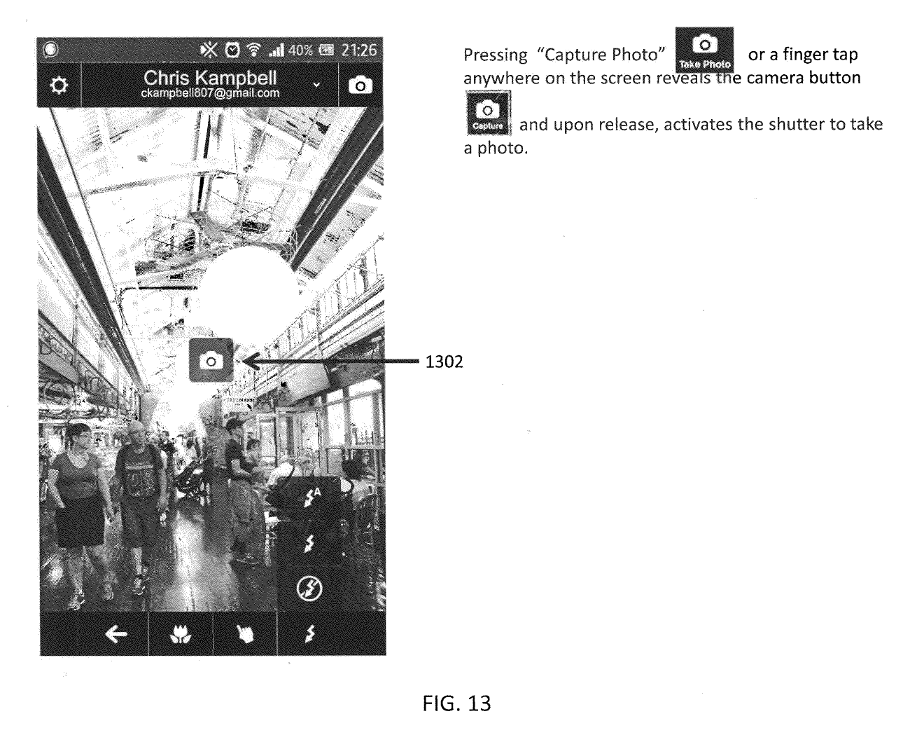

FIG. 13 illustrates a photo capture interface of the KasahComm application in accordance with embodiments of the present invention. The user can select anywhere within the screen to reveal the camera button 1302, which activates the built-in camera within the KasahComm application. Releasing the camera button triggers the camera to capture the photo.

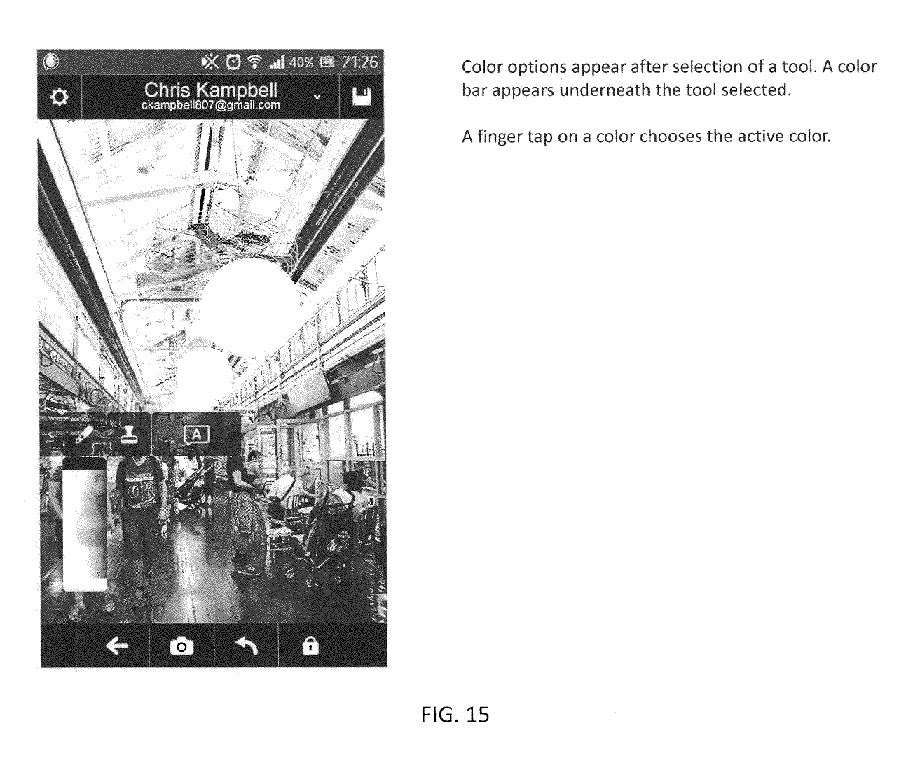

In embodiments, the KasahComm application allows users to edit images. In particular, the KasahComm application allows users to add one or more of the following to images: hand-written drawings, overlaid text, watermarking, masking, layering, visual effects such as blurs, and preset graphic elements along with the use of a selectable color palette. FIG. 14 illustrates a photo editing interface in accordance with embodiments of the present invention. Once the KasahComm application captures a photo, the KasahComm application provides a photo editing menu: a color selection icon, a free-hand line drawing icon 1404, a stamp icon 1406, a text icon 1408, and a camera icon 1410. This photo editing icons 1404, 1406, and 1408 are displayed in the currently selected color for editing with that tool. When a user selects any of the editing icons, 1404, 1406, and 1408, the KasahComm application provides a plurality of color options, as illustrated in FIG. 15 in accordance with embodiments of the present invention. When a user selects one of the plurality of color options, the KasahComm application uses the selected color for further editing. In addition, when a user selects the text icon 1408, the KasahComm application activates the keyboard text tool to type on the photo. When a user selects the camera icon 1410, the KasahComm application activates the photo capturing tool to recapture a photo.

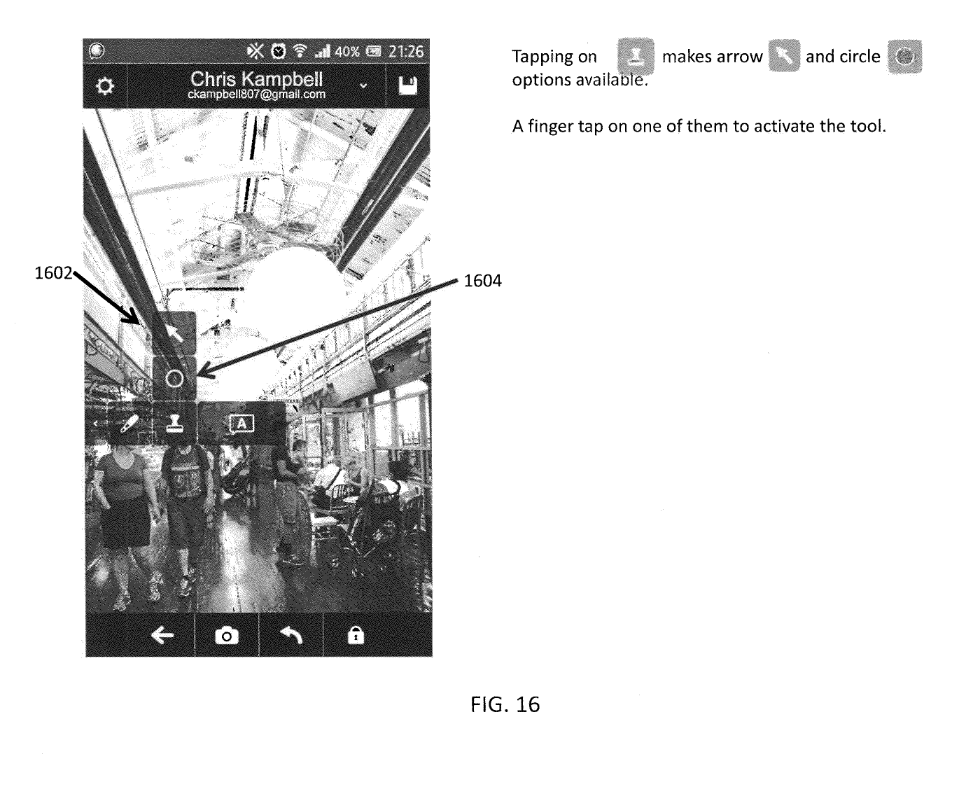

When a user selects the stamp icon 1406, the KasahComm application activates the stamp tool to modify the photo using preset image stamps such as circles and arrows. FIG. 16 illustrates a use of the stamp interface in the KasahComm application in accordance with embodiments of the present invention. When a user selects the arrow 1602 or the circle 1604 button, the KasahComm application can activate the tool associated with the selected button.

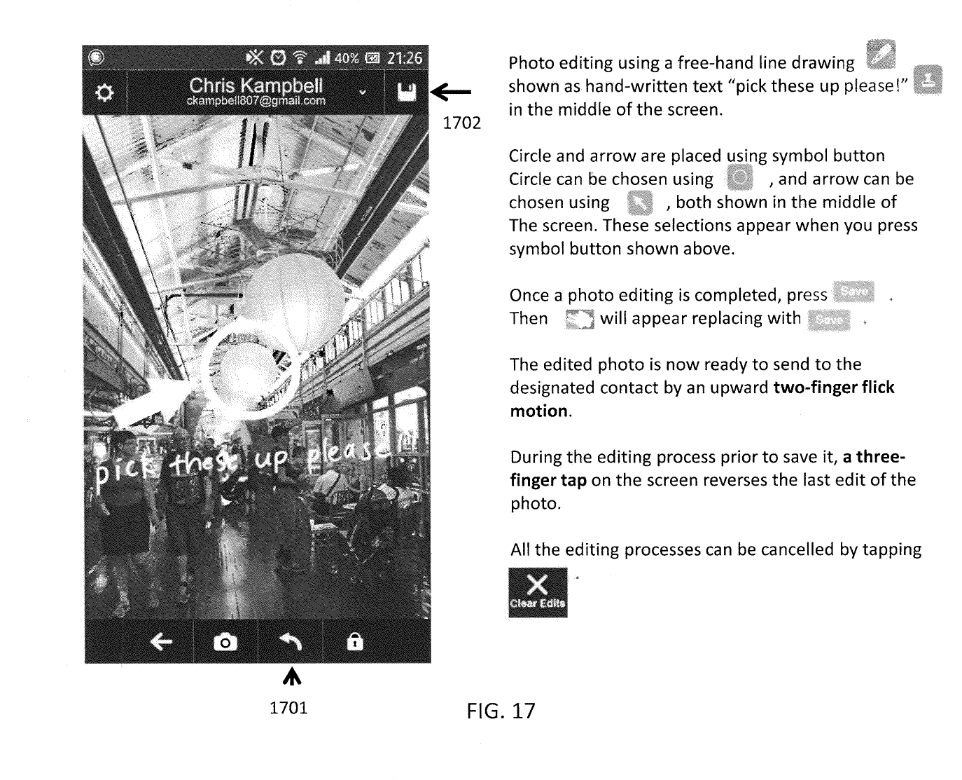

When a user selects the free-hand line drawing icon 1404, the KasahComm application activates the free-hand line drawing tool to modify the captured photo. FIG. 17 illustrates a use of the free-hand line drawing interface and stamp interface in the KasahComm application in accordance with embodiments of the present invention. The user can use the free-hand line drawing tool and stamp tool to add a graphic layer on top of the photograph. In embodiments, the user can reverse the last modification of the photograph by a three-finger select on the screen. In embodiments, all the modifications on the photograph can be cancelled by selecting the “Cancel” button 1702. Once a photo editing is completed, the user can press a “save” button 1704 to save the modified photograph. In embodiments, the user can send the modified photograph to the designated contact by an upward two-finger flick motion.

In embodiments, an image editor can use a weighted input device to provide more flexibility in image editing. The weighted input device can include a touch input device with a pressure sensitive mechanism. The input device with a pressure sensitive mechanism can detect the pressure at which the touch input is provided. The input device can include a resistive touch screen, or a stylus. The input device can use the detected pressure to provide additional features. For example, the detected pressure can be equated to a weight of the input. In embodiments, the detected pressure can be proportional to the weight of the input.

The weighted input device can include a input device with a time sensitive mechanism. The time sensitive input mechanism can adjust the weight of the input based on the amount of time during which a force is exerted on the input device. The amount of time during which a force is exerted can be proportional to the weight of the input.

In embodiments, the weighted input device can use both the pressure sensitive mechanism and the time sensitive mechanism to determine the weight of the input. The weight of the input can also be determined based on a plurality of touch inputs. Non-limiting applications of the weighted input device can include controlling the differentiation in color, color saturation, or opacity based on the weighted input.

Oftentimes, an input device, such as a touch screen, uses a base shape to represent a user input. For example, a touch screen would model a finger touch using a base shape. The base shape can include one of a circle, a triangle, a square, any other polygons or shapes, and any combinations thereof. The input device often represents a user input using a predetermined base shape.

Unfortunately, a predetermined base shape can limit the flexibility of a user input. For example, different fingers can have a different finger size or a different finger shape, and these differences cannot be captured using a predetermined base shape. This can result in a non-intuitive user experience in which a line drawn with a finger is not in the shape or size of the finger, but in the selected “base shape.” This can be visualized by comparing a line drawn with your finger on a smartphone application and a line drawn with your finger in sand. While the line drawn on a smartphone application would be in the thickness of the predetermined base shape, the line drawn in the sand would directly reflect the size and shape of your finger.

To address this issue, in embodiments, the base shape of the input is determined based on the actual input received by the input device. For example, the base shape of the input can be determined based on the size of the touch input, shape of the touch input, received pressure of the touch input, or any combinations thereof. This scheme can be beneficial in several ways. First, this approach provides an intuitive user experience because the tool shape would match the shape of the input, such as a finger touch. Second, this approach can provide an ability to individualize user experience based on the characteristics of the input, such as a size of a finger. For example, one person's finger can have a different base shape compared to another person's base shape. Third, this approach provides more flexibilities to users to use different types of input to provide different imprints. For example, a user can use a square shaped device to provide a square shape user input to the input device. This experience can be similar to using pre-designed stamps, mimicking the usage of rubber ink stamps on the input device: for design purposes, to serve as a “mark” (approval, denied, etc.), or to provide identification (family seal).

In embodiments, the detected base shape of the input can be used to automatically match user interface elements, which can accommodate the differences in finger sizes. In embodiments, users can select the base shape of the input using selectable preset shapes.

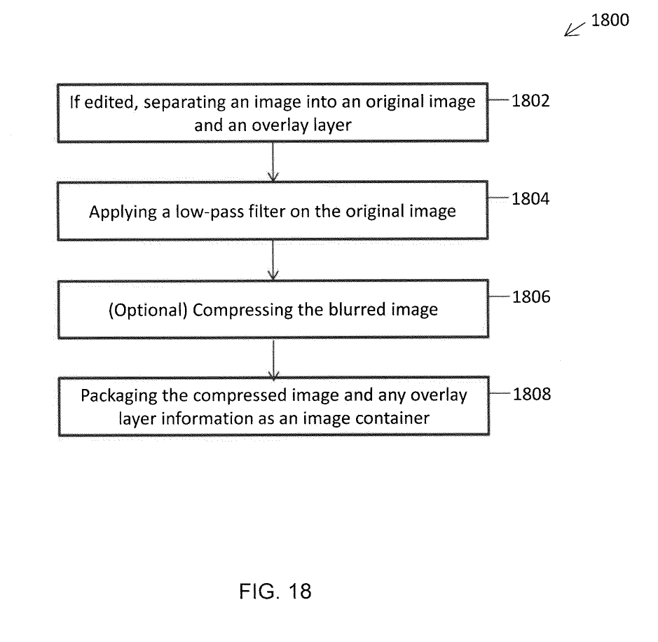

In embodiments, the KasahComm application manages digital images using an efficient data representation. For example, the KasahComm application can represent an image as (1) an original image and (2) any overlay layers. The overlay layers can include information about any modifications applied to the original image. The modifications applied to the original image can include overlaid hand-drawings, overlaid stamps, overlaid color modifications, and overlaid text. This representation allows a user to easily manipulate the modifications. For instance, a user can easily remove modifications from the edited image by removing the overlay layers. As another example, the KasahComm application can represent an image using a reduced resolution version of the underlying image. This way, the KasahComm application can represent an image using a smaller file size compared to that of the underlying image. The efficient representation of image(s), as illustrated in FIGS. 18-20, can drastically reduce the amount of required storage space for storing image(s) and also the required data transmission capacity for transmitting image(s) to other computing devices 106.

FIG. 18 illustrates a process 1800 of providing an efficient representation of an image in accordance with embodiments of the present invention. In step 1802, if the image has been edited, the KasahComm application can decouple the edited image into an original image and an overlay layer.

In step 1804, the KasahComm application can apply (or operate) a defocus blur to the underlying original image (i.e., without any image edits.) The KasahComm application can operate a defocus blur to the underlying original image using a convolution operator. For example, the KasahComm application can convolve the underlying original image with the defocus blur. The defocus blur can reduce the resolution of the image, but at the same time, reduce the amount of data (i.e., number of bits) needed to represent the image.

In embodiments, the defocus blur can include with a smoothing operator, such as a low-pass filter. The low-pass filter can include a Gaussian blur filter, a skewed Gaussian blur filter, a box filter, or any other filters that reduce the high frequency information of the image.

The defocus blur can be associated with one or more parameters. For example, the Gaussian blur filter can be associated with parameters representing (1) the size of the filter and (2) the standard deviation of the Gaussian kernel. As another example, the box filter can be associated with one or more parameters representing the size of the filter. In some cases, the parameters of the defocus blur can be determined based on the readout from the autofocus function of the image capture device. For example, starting from an in-focus state, the image capture device forces its lens to defocus and records images over a range of defocus settings. Based on the analysis of the resulting compression rate and decompression quality associated with each of the defocus settings, optimized parameters can be obtained.

In embodiments, some parts of the image can be blurred more than other parts of the image. In some cases, the KasahComm application can blur some parts of the image more than other parts of the image by using different defocus blur to different parts of the image.

In step 1806, the KasahComm application can optionally compress the defocused image using an image compression system. This step is an optional step to further reduce the file size of the image. The image compression system can implement one or more image compression standards, including the JPEG standard, the JPEG 2000 standard, the MPEG standard, or any other image compression standards. Once the defocused image is compressed, the file size of the resulting image file can be substantially less than the file size of the original, in-focus image file.

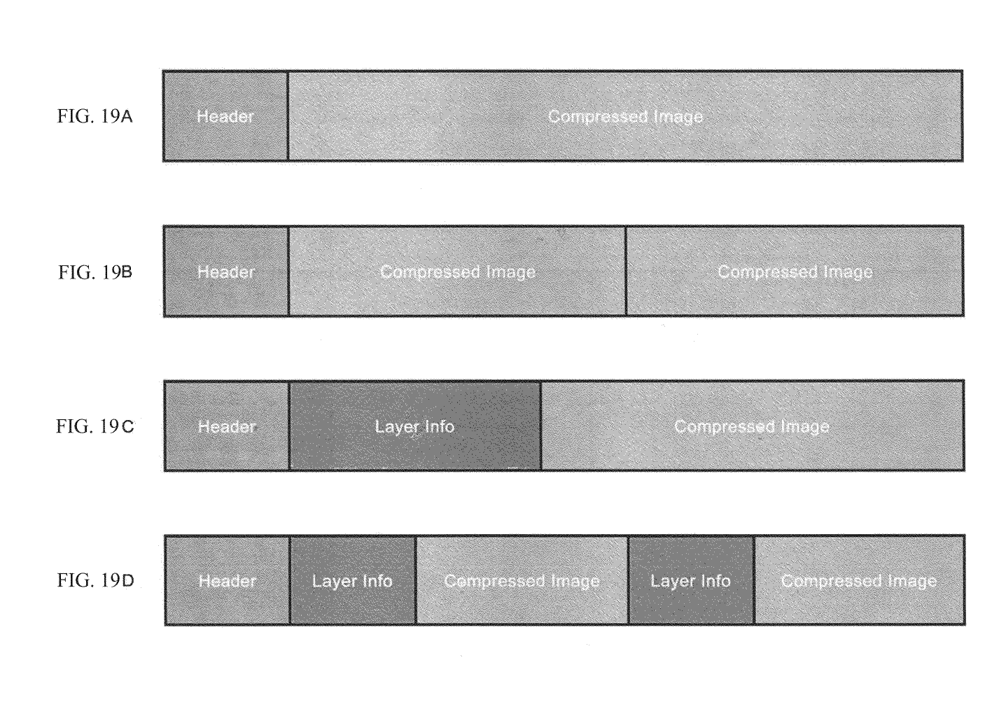

In step 1808, the resulting compressed image file can be packaged in an image container. FIGS. 19A-19D illustrate various types of an image container in accordance with embodiments of the present invention. FIG. 19A shows an image container for accommodating a single compressed image. For example, the image container can include header information and data associated with the compressed image. FIG. 19B shows an image container for accommodating more than one compressed image. For example, the image container can include header information and data associated with the more than one compressed image. FIG. 19C shows an image container for accommodating an edited image. For example, the image container can include header information, data associated with the compressed, original image, and the overlay layer. FIG. 19D shows an image container for accommodating more than one edited image. For example, the image container can include header information, data associated with the compressed, original images, and the overlay layers associated with the compressed, original images.

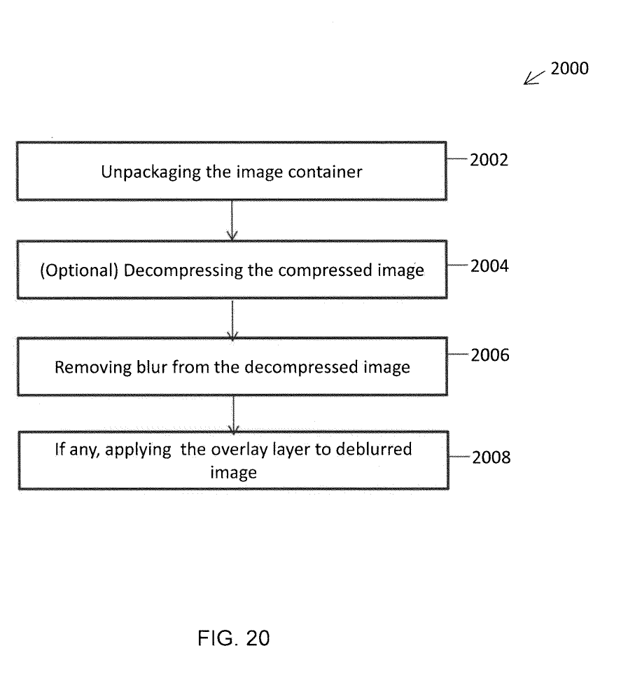

The KasahComm application can recover images from the efficient image representations of FIG. 19 using an image recovery procedure. FIG. 20 illustrates an image recovery procedure 2000 in accordance with embodiments of the present invention. In step 2002, the KasahComm application can unpackage the image container to separate out the compressed, original image(s) and the corresponding overlay layer(s). In step 2004, the KasahComm application can decompress the compressed, original image(s), if the defocused image was compressed using a compression algorithm in step 1806. In step 2006, the KasahComm application can remove the defocus blur in the decompressed image(s). The deconvolution algorithm can be based on iterative and/or inverse filter methodologies. In step 2008, the KasahComm application can apply any overlay layer(s) to the deconvolved images to reconstruct the edited image(s).

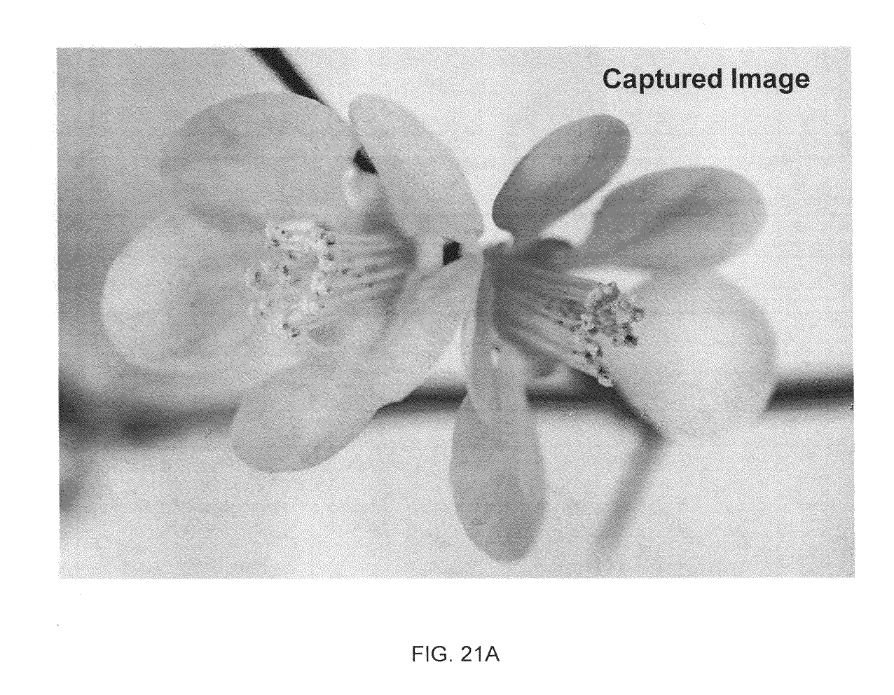

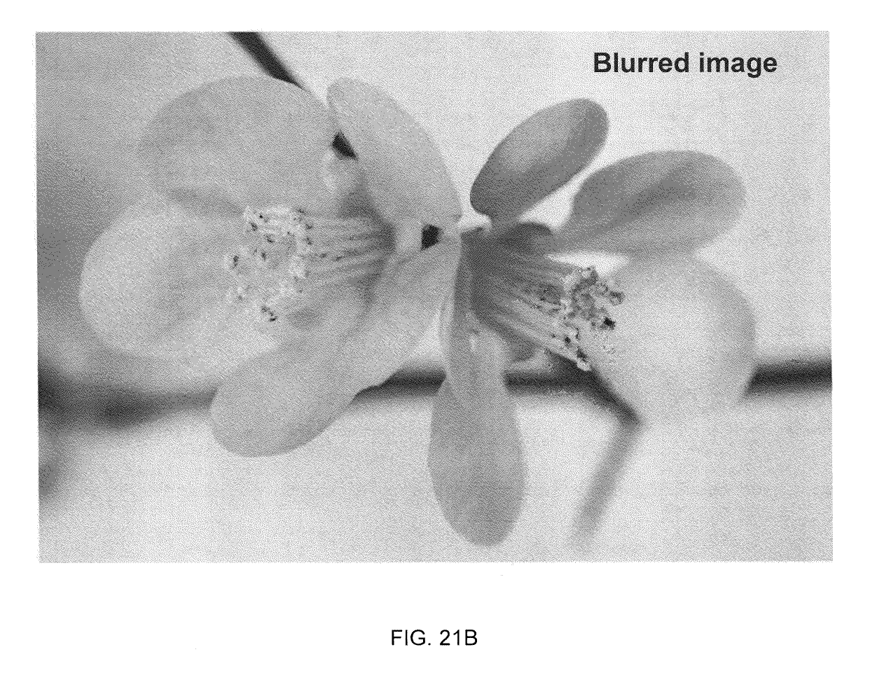

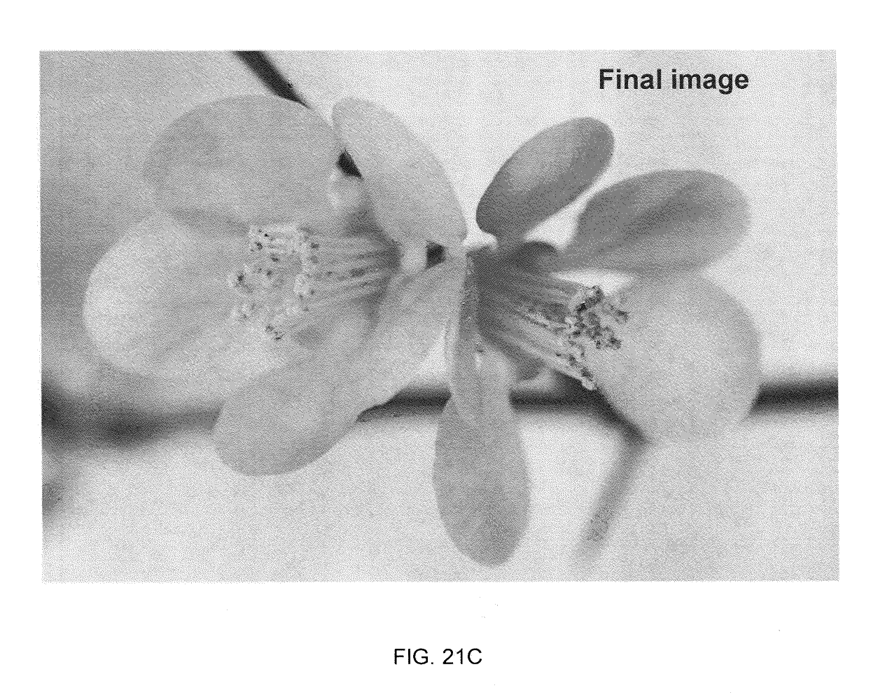

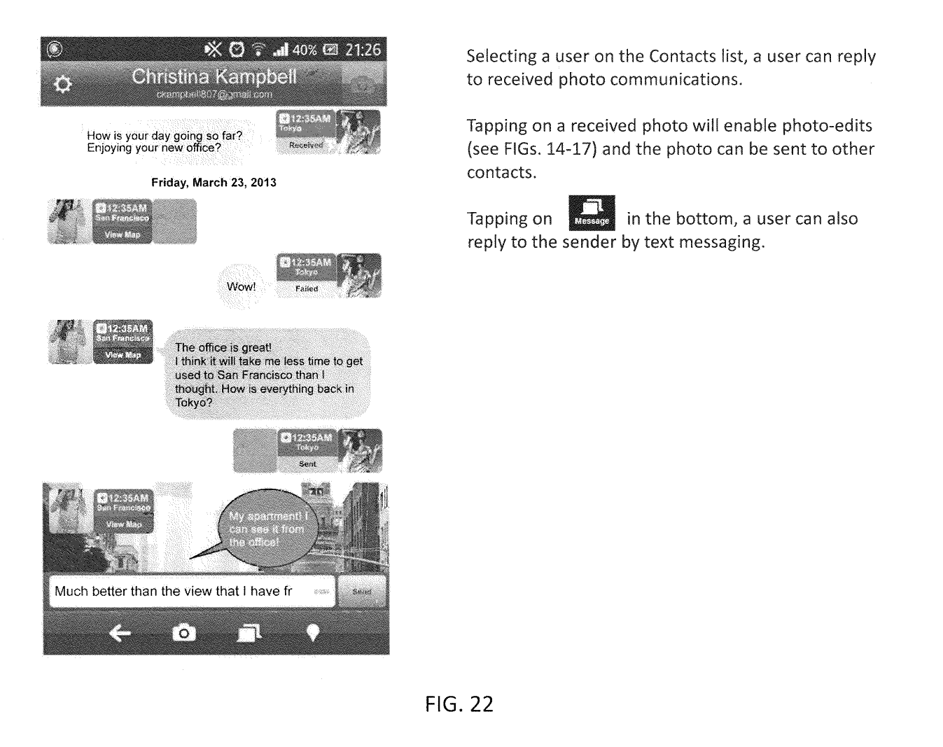

FIGS. 21A-21C illustrate the effectiveness of the steps in FIGS. 18-20. FIG. 21A illustrates a captured photo using a digital camera. The captured photograph is in a JPEG format and has a file size of 5.8 MB. This captured photograph is defocused by convolving the photograph with a Gaussian blur filter with σ=1. The defocused photograph is shown in FIG. 21B. Upon convolving the photograph, the image has a file size of 827 KB, which is significantly less than the original file size. This defocused photograph can be deconvolved using an unsharp mask filtering to recover the sharp image, as illustrated in FIG. 21C.

The efficient image representation, as illustrated in FIGS. 18-20, can be useful for communication between computing devices over a communication network. For example, one user of the KasahComm application can attempt to send an edited image to another user of the KasahComm application over the communication network. In such cases, before the KasahComm application transmits the edited image, the application can compress the image using the steps illustrated in FIG. 18. Once the KasahComm application of another computing device receives the transmitted image, the application can reconstruct the image using the steps illustrated in FIG. 20.

In embodiments, the receiving KasahComm application can further modify the received image. For example, the receiving KasahComm application can eliminate modifications made by the sender KasahComm application or add new modifications. When the receiving KasahComm application completes the modification, the receiving KasahComm application can send the modified image back to the sending KasahComm application. In some cases, the receiving KasahComm application can store the modified image as a compressed or decompressed data file, and/or display the data file contents on a digital output device or on an analog output device by utilizing the necessary a digital to analog converter.

In embodiments, the KasahComm application can enable multiple users to share messages over a communication network. The messages can include texts, photographs, videos, or any other types of media. In this communication mechanism, the KasahComm application can use the image compression/decompression scheme of FIG. 18-20. When a user receives a message, the KasahComm application can alert the user of the received messages using either or both auditory and visual signals. The auditory and visual signals can include light impulses.

In embodiments, when a user receives a message, the user can respond to the received message by selecting the name of the user sending the message. FIG. 22 illustrates an interface for replying to a received message in accordance with embodiments of the present invention. In embodiments, when the user selects the received photograph, the user can enable the photo-edits, as illustrated in FIGS. 14-17. Once the user modifies the received photograph, the user can send the modified photograph to other users in the Contacts list.

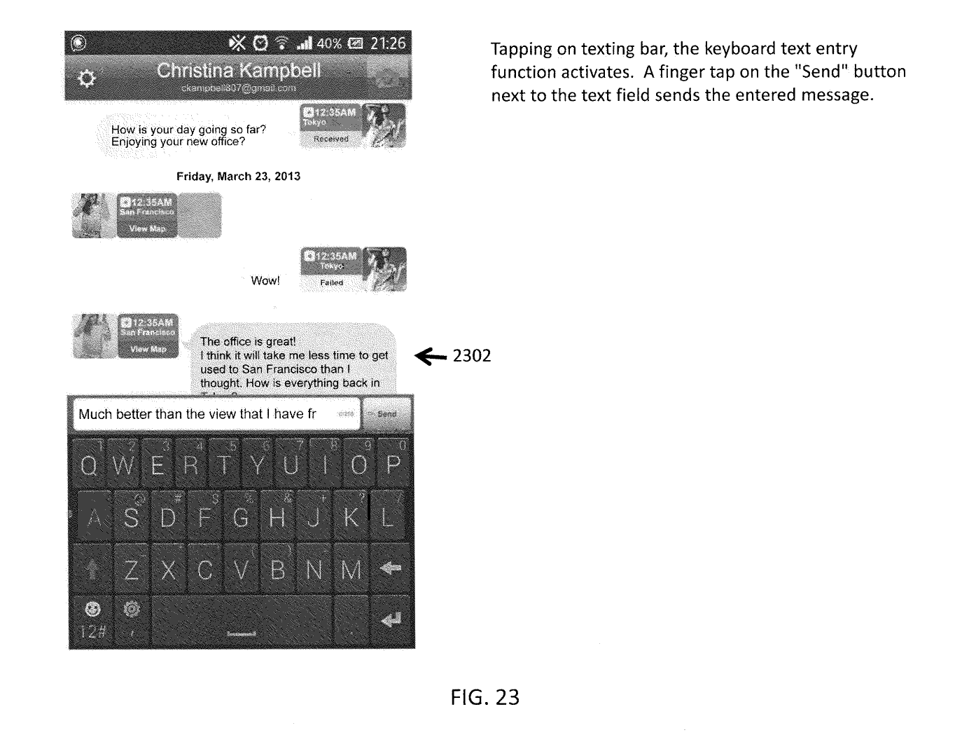

In embodiments, when the user selects the text bar at the bottom, the user can reply to the sender of the photograph by text messaging. FIG. 23 illustrates a keyboard text entry interface in accordance with embodiments of the present invention. When the user selects the “Send” button 2302 next to the text field, the KasahComm application can send the entered message in the text field.

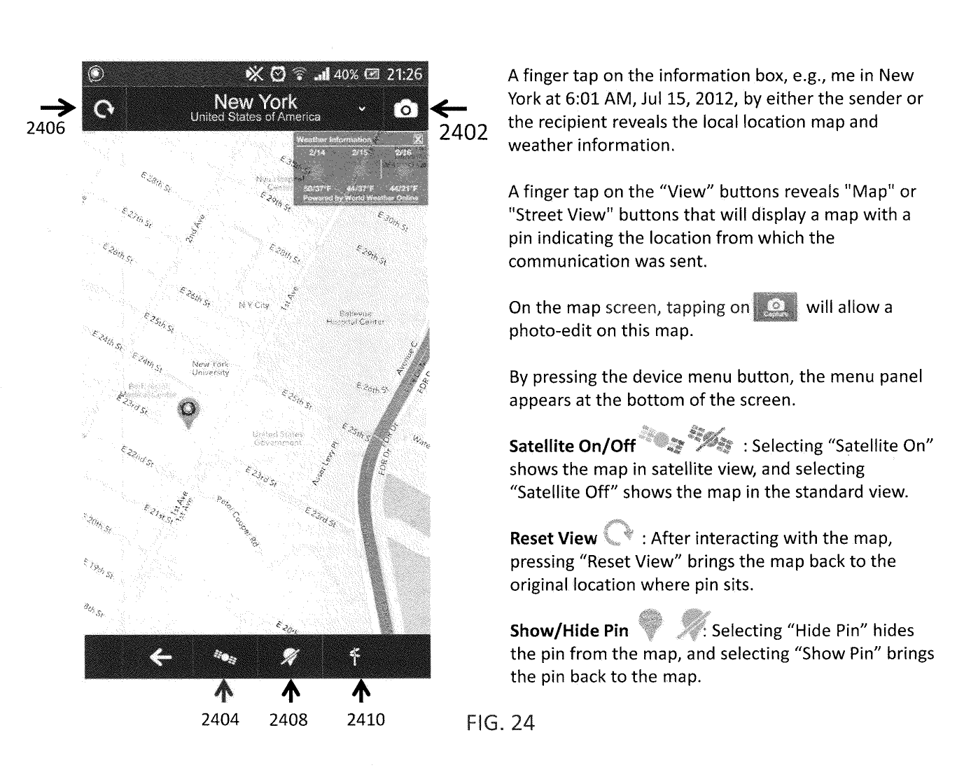

In embodiments, the photograph can include metadata, such as the location information. The KasahComm application can use this information to provide additional services to the user. FIG. 24 illustrates how the KasahComm application uses the location information associated with the photograph to provide location services to the user in accordance with embodiments of the present invention. When a user selects the information box, the recipient can reveal the local weather and the local location map. When the user selects the “Map” or “Street View” buttons, the KasahComm application can display the map with a pin that indicates the location from which the user sent the communication.

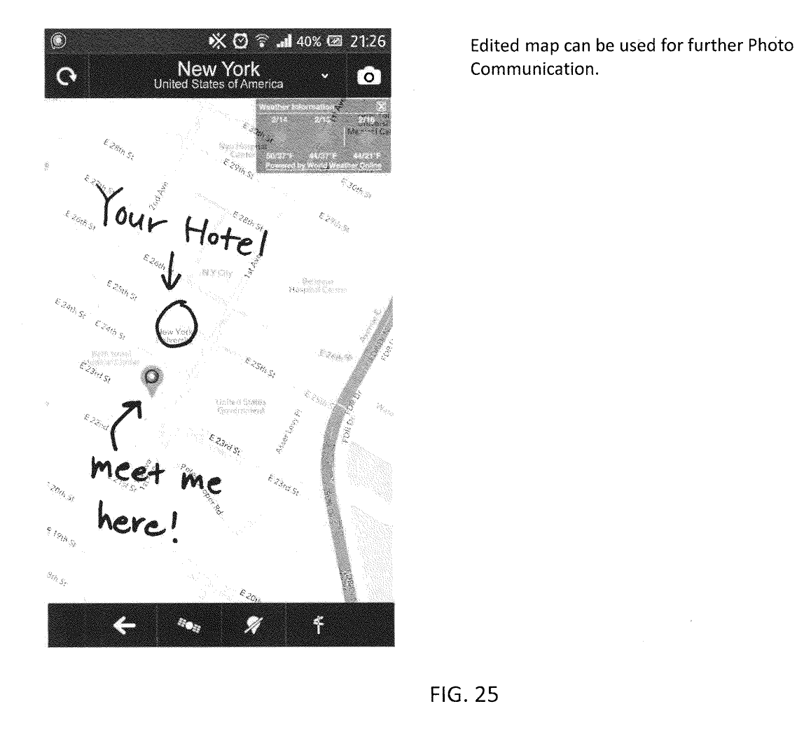

In embodiments, the KasahComm application can allow a user to modify a map. FIG. 24 illustrates a user interaction to modify a map in accordance with embodiments of the present invention. When a user selects the capture icon 2402, the KasahComm application can allow the user to modify the displayed map, using the photo editing tools illustrated in FIGS. 14-17. FIG. 25 illustrates the modified map in accordance with embodiments of the present invention.

In embodiments, the KasahComm application can enable other types of user interaction with the map. FIG. 24 illustrates user interactions with a map in accordance with embodiments of the present invention. When the user selects a device menu button, a menu interface can appear at the bottom of the screen. The menu interface can include a “Satellite On/Off” button 2404, a “Reset View” button 2406, a “Show/Hide Pin” 2408, and an “View” button 2410. When the user selects the “Satellite On,” the KasahComm application can show the map in a satellite view (not shown). When the user selects the “Satellite Off,” the KasahComm application can show the map in the standard view (as shown in FIG. 24). When the user zooms in or out of the map or moves around the map, and if the user wants to reset the map to the original zoom setting/position, the user can press the “Reset View” button 2406 to bring the map back to the original location where the original pin sits. The user can press the “Show/Hide Pin” button 2408 to show or hide the pin from the map, respectively. When the user presses on the “View” button 2410, the KasahComm application can show the location using the map application on the device.

In embodiments, the KasahComm applications on mobile devices can determine the location of the users and share the location information amongst the KasahComm applications. In some cases, the KasahComm applications can determine the location of the users using a Global Positioning System (GPS.) Using this feature, the KasahComm application can deliver messages to users at a particular location. For example, the KasahComm application can inform users within a specified area of an on-going danger.

In embodiments, the KasahComm application can accommodate a multiple resolution image data file where certain portions of the image are of higher resolution compared to other portions. In other words, a multiple resolution image data file can have a variable resolution at different positions in an image.

The multiple resolution image can be useful in many applications. The multiple resolution image can maintain a high resolution in areas that are of higher significance, and a lower resolution in areas of lower significance. This allows users to maintain high resolution information in the area of interest, even when there is a restriction on the file size of the image. For example, a portrait image can be processed to maintain high resolution information around the face, while, at the same time, reduce resolution in other regions to reduce the file size. Considering that users tend to zoom in on the areas of most significance, in this case, the facial region, the multiple resolution image would not significantly degrade the user experience, while achieving a reduced file size of the image.

In some cases, the multiple resolution image can be useful for maintaining high resolution information in areas that are necessary for subsequent applications, while reducing the resolution of regions that are unnecessary for subsequent applications. For example, in order for text or bar code information to be read reliably by, e.g., users or by bar code readers, high resolution information of the text or the bar code can be crucial. To this end, the multiple resolution image can maintain high resolution information in areas with text or bar code information, while reducing the resolution in irrelevant portions of the image.

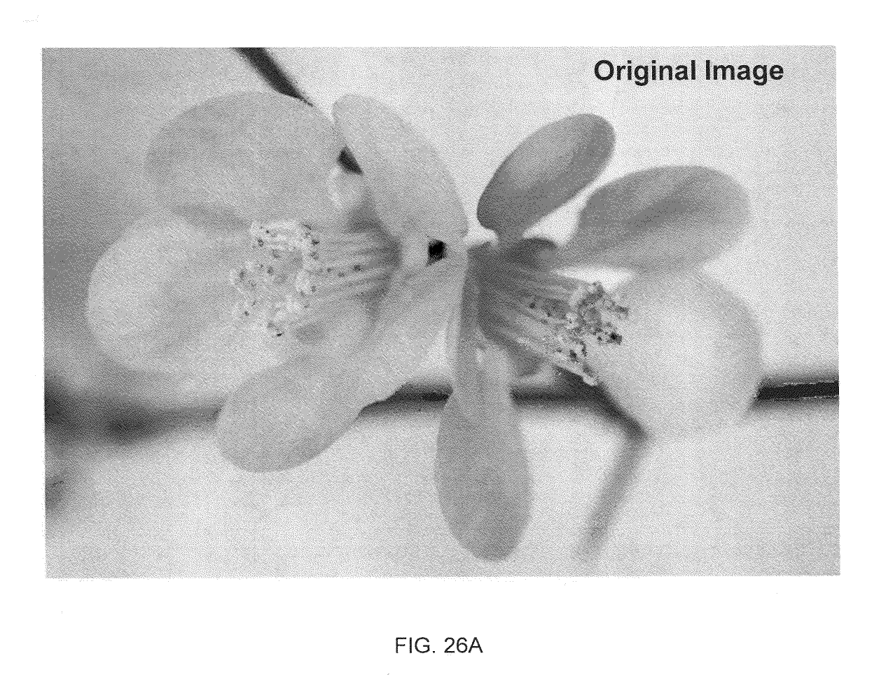

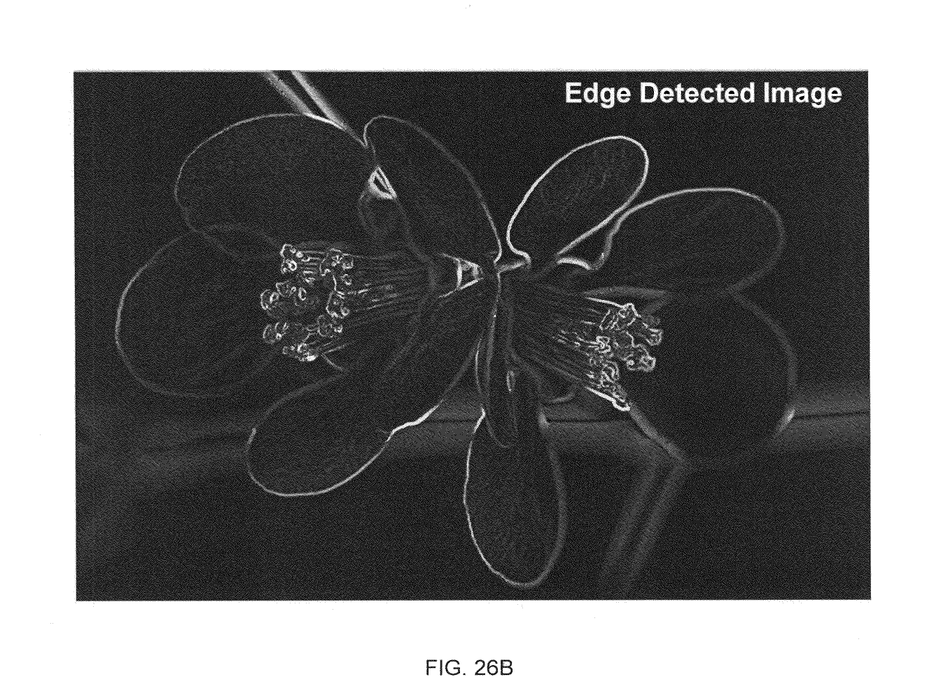

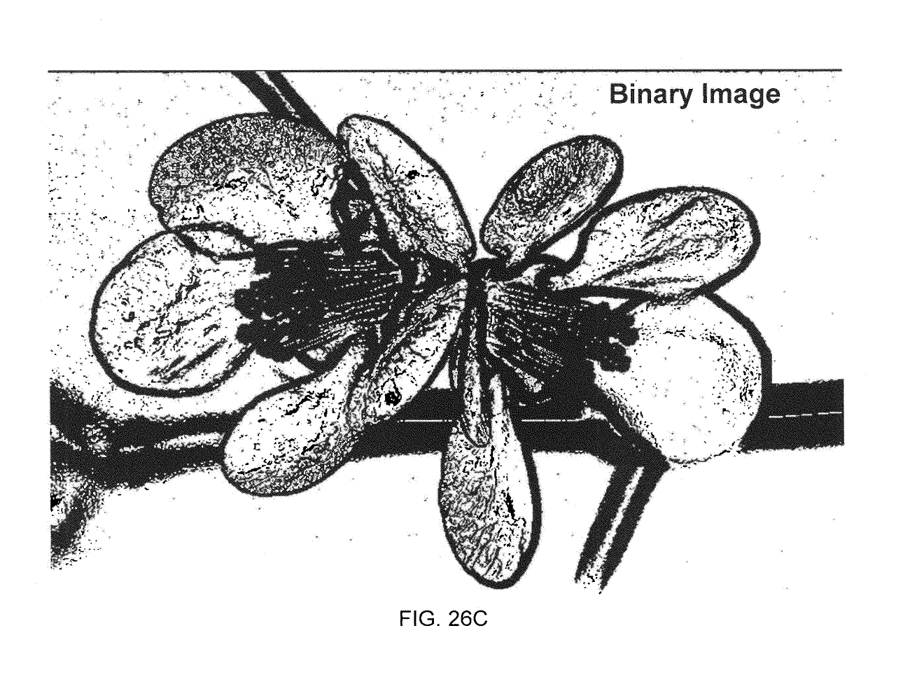

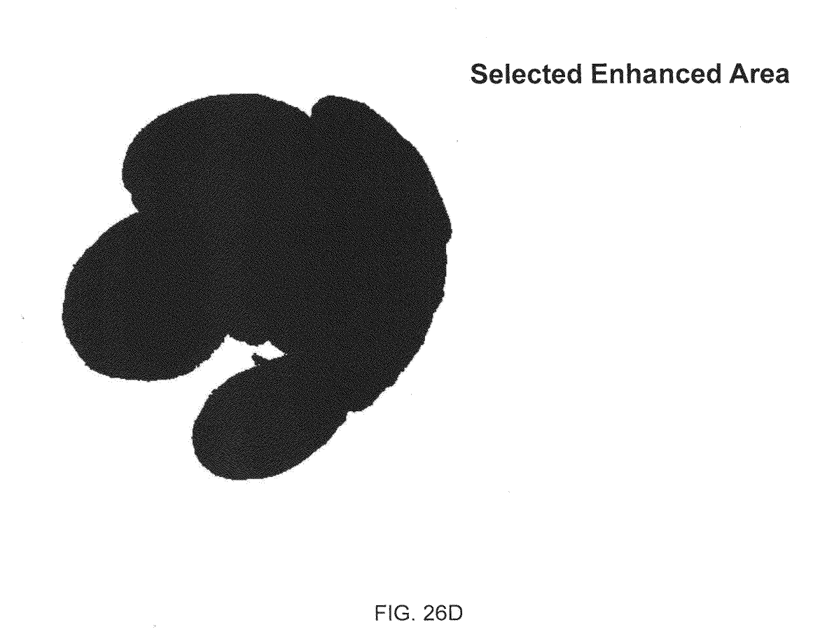

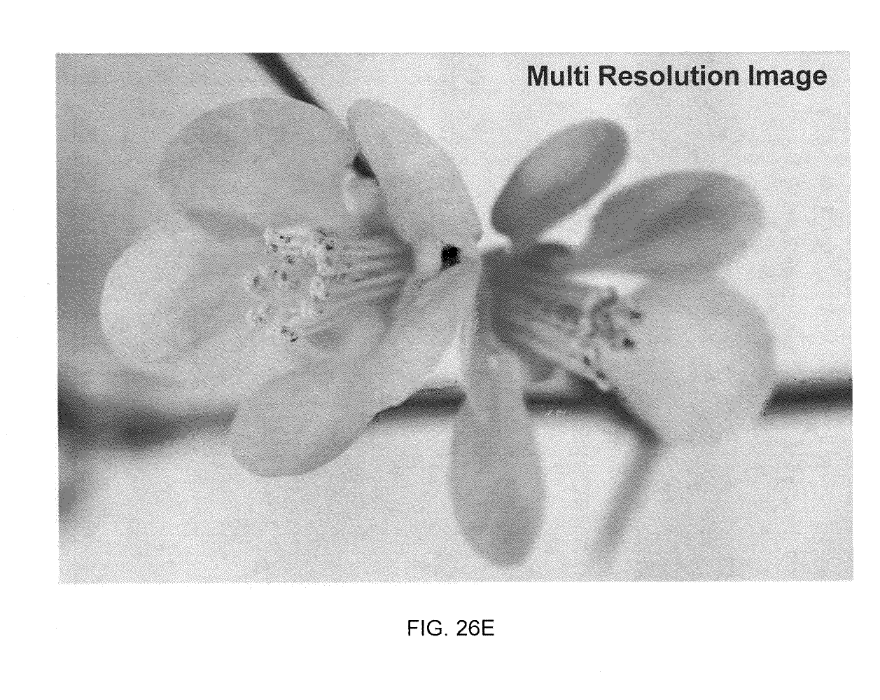

A multiple resolution image data file can be generated by overlaying one or more higher resolution images on a lower resolution image while maintaining x-y coordinate data. FIGS. 26A-26E illustrate a process of generating a multiple resolution image data file in accordance with embodiments of the present invention. FIG. 26A shows the original image file. The file size of the original image is 196 kb. The first step of the process includes processing the original image to detect edges in the original image. In embodiments, edges can be detected by convolving the original image with one or more filters. The one or more filters can include any filters that can extract high frequency information from an image. In embodiments, the filters can include a first-order gradient filter, a second-order gradient filter, a higher-order gradient filters, wavelet filters, steerable filters, or any combinations thereof. FIG. 26B shows the edge enhanced image of the original image in accordance with embodiments of the present invention.

The second step of the process includes processing the edge enhanced image to create a binary image, typically resulting in a black and white image. In embodiments, the binary image can be created by processing the edge enhanced image using filters. The filters can include color reduction filters, color separation filters, color desaturation filters, brightness and contrast adjustment filters, exposure adjustment filter, and/or image history adjustment filters. FIG. 26C shows a binary image corresponding to the edge enhanced image of FIG. 26B.

The third step of the process includes processing the binary image to detect areas to be enhanced, also called a target region. The target region is the primary focus area of the image. In embodiments, the target region can be determined by measuring the difference in blur levels across the entire image. In other embodiments, the target region can be determined by analyzing the prerecorded focus information associated with the image. The focus information can be gathered from the image capture device, such as a digital camera. In embodiments, the target region can be determined by detecting the largest area bound by object edges. In embodiments, the target region can be determined by receiving a manual selection of the region from the user using, for example, masking or freehand gestures. In embodiments, any combinations of the disclosed methods can be used to determine the target region.

The dark portion of the image mask, shown in FIG. 26D, illustrates an area of the image that should retain high resolution of the original image. In embodiments, the image mask can be automatically generated. In other embodiments, the image mask can be generated in response to user inputs, for example, zooms, preconfigured settings, or any combinations thereof.

The multiple resolution image can be generated by sampling the original image within the selected enhanced area indicated by the image mask, and filling in the non-selected area with a blurred, low-resolution image. FIG. 26E shows the multiple resolution image generated by the disclosed process. In this example, the file size of the final multiple resolution image is 132 kb. Therefore, the resulting file size is only 67.3% of the original file size. In embodiments, the resolution of the image in the non-selected areas can be constant. In other embodiments, the resolution of the image in the non-selected areas can be varied. In some cases, the resolution in the non-selected areas can be determined automatically. In other cases, the resolution in the non-selected areas can be determined in response to user inputs, for example, zooms, preconfigured settings, or any combinations thereof.

In embodiments, systems and methods of the disclosed subject matter may utilize multi-layer video files where video bookmarks can be created on existing video files to provide fast access to specific frames within the video file. The video bookmarks may be accompanied with image or text information layered over the video image.

In embodiments, systems and methods of the disclosed subject matter may be used to create image and text that can be layered over a video image. Such image and text information may be frame based where the edit would only exist corresponding to select frames, or across several or all frames, where the added image and text information will result in an animation layered over the original video.

In embodiments, the KasahComm application may process audio information to create visual and audio output. The visual and audio output can be created based on predetermined factors. The predetermined factors can include one or more of data patterns, audio output frequency, channel output, gain, peak, and the Root Mean Squared (RMS) noise level. The resulting visual output may be based on colors, images, and text.

In embodiments, the KasahComm application can provide a visual representation of audio information. This allows physically disabled people, including deaf people, to interact with audio information.

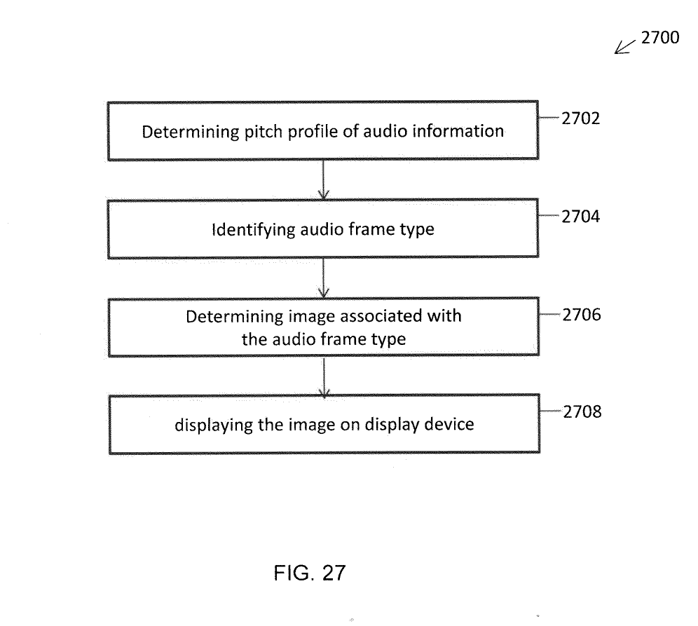

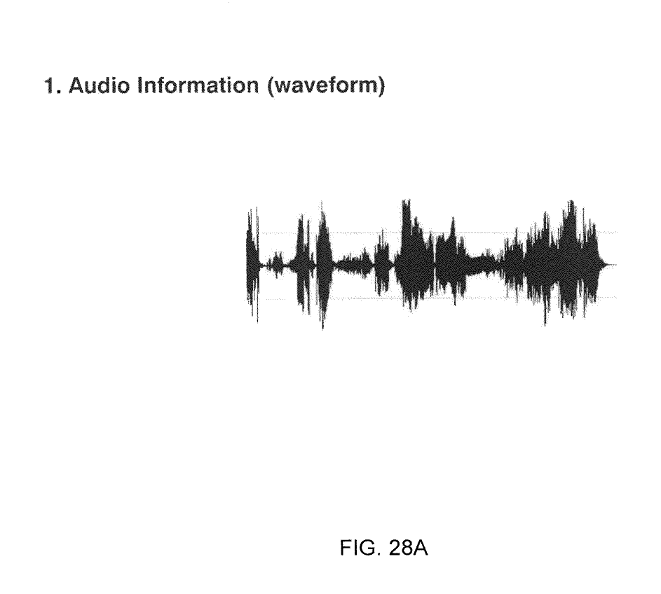

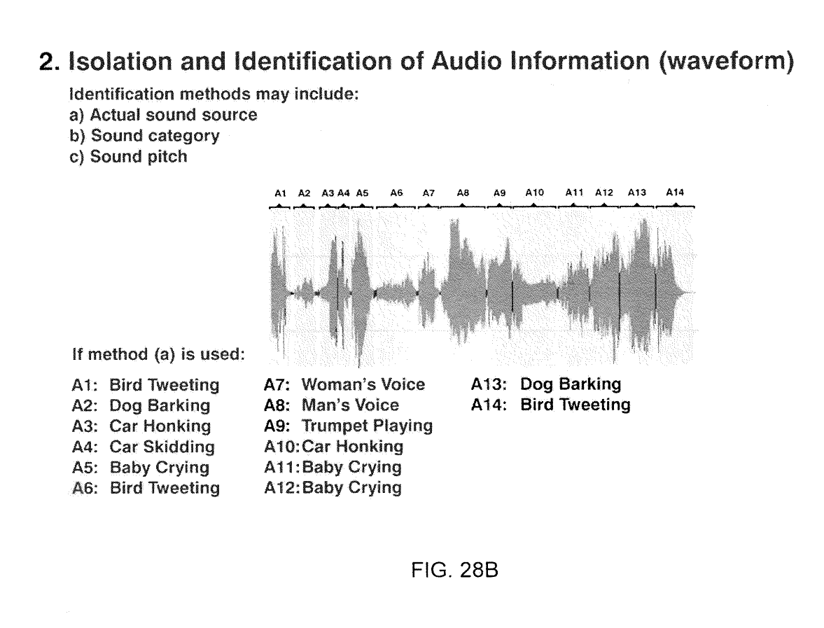

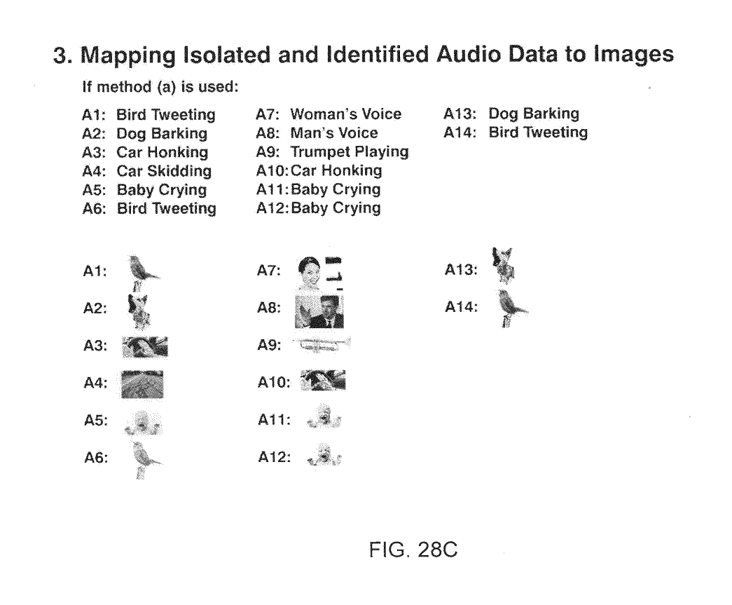

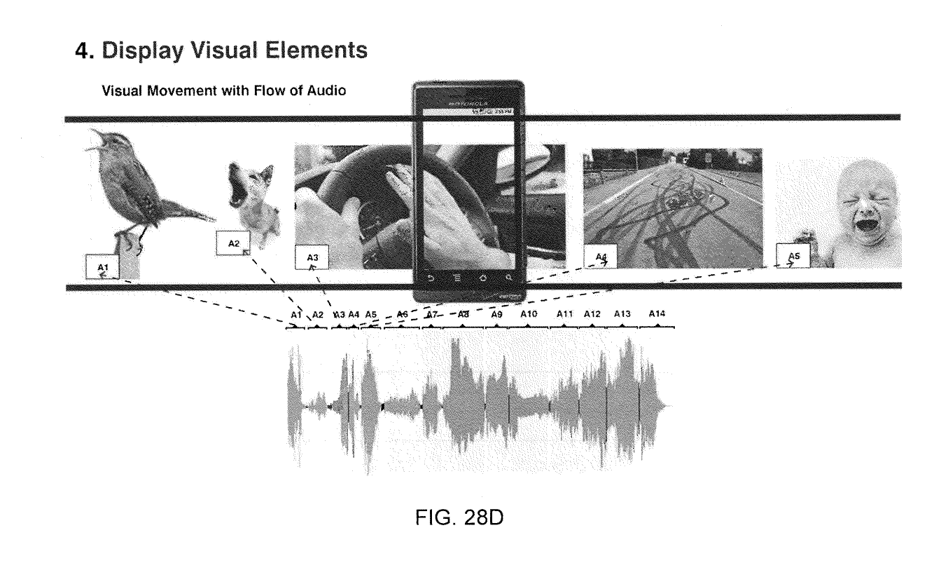

FIG. 27 illustrates a flow chart 2700 for generating a visual representation of audio information in accordance with embodiments of the present invention, and FIGS. 28A-28D show a visualization of the process of generating the visual representation of audio information in accordance with embodiments of the present invention. In step 2702, a computing system can determine a pitch profile of audio information. FIG. 28A shows a pitch profile of audio information in a time domain. This audio information can be considered a time sequence of a plurality of audio frames.

In embodiments, each audio frame can be categorized as one of sound types. For example, an audio frame can be categorized as a bird tweeting sound or as a dog barking sound. Thus, in step 2704, the computing system can identify an audio frame type associated with one of the audio frames in the audio information: the audio information can be processed to determine whether the audio information includes audio frames of a particular type. FIG. 28B illustrates a process for isolating and identifying audio frames of a certain sound type from audio information. In embodiments, the sound type can be based on the sound source that generates the sound. The sound source can include, but is not limited to, (a) bird tweeting, (b) dog barking, (c) car honking, (d) car skidding, (e) baby crying, (f) woman's voice, (g) man's voice, and (h) trumpet playing.

In embodiments, identifying a type of audio frame from audio information can include measuring changes in pitch levels (or amplitude levels) in the input audio information. The changes in the pitch levels can be measured in terms of the rate at which the pitch changes, the changes in the amplitude, measured by decibels, the changes in the frequency content of the input audio information, the changes in the wavelet spectral information, the changes in the spectral power of the input audio information, or any combinations thereof. In embodiments, identifying a certain type of audio frame from audio information can include isolating one or more repeating sound patterns from the input audio information. Each repeating sound pattern can be associated with an audio frame type. In embodiments, identifying a certain type of audio frame from audio information can include comparing the pitch profile of the input audio information against pitch profiles associated with different sound sources. The pitch profiles associated with different sound sources can be maintained in an audio database.

In embodiments, identifying a certain type of audio frame from audio information can include comparing characteristics of the audio information against audio fingerprints. Each audio fingerprint can be associated with a particular sound source. The audio fingerprint can be characterized in terms of average zero crossing rates, estimated tempos, average spectrum, spectral flatness, prominent tones across a set of bands and bandwidth, coefficients of the encoded audio profile, or any combinations thereof.

In embodiments, the sound types can be based on a sound category or a sound pitch. The sound categories can be organized in a hierarchical manner. For example, the sound categories can include a general category and a specific category. The specific category can be a particular instance of the general category. Some examples of the general/specific categories include an alarm (general) and a police siren (specific), a musical instrument (general) and a woodwind instrument (specific), a bass tone (general) and a bassoon sound (specific). The hierarchical organization of the sound categories can enable a trade-off between the specificity of the identified sound category and the computing time. For example, if the desired sound category is highly specific, then it would take a long time to process the input audio information to identify the appropriate sound category. However, if the desired sound category is general, then it would only take a short amount of time to process the input audio information.

Once an audio frame is associated with an audio frame type, in step 2706, the audio frame can be matched up with an image associated with that audio frame type. To this end, the computing system can determine an image associated with the audio frame type. FIG. 28C illustrates the association between images and sound types. For example, an image associated with the sound type “Bird Tweeting” is an image with a bird; an image associated with the sound type “Car Honking” is an image with showing a hand on a car handle. The association between the image and the sound type can be maintained in a non-transitory computer readable medium. For example, the association between the image and the sound type can be maintained in a database.

Once each audio frame is associated with one of the images, in step 2708, the computing system can display the image on a display device. In some cases, the time-domain audio information can be supplemented with the associated images as illustrated in FIG. 28D. This allows the users to visualize the flow of the underlying audio information without having to actually listen to the audio information. Non-limiting applications of creating a visualization of audio information can include an automated creation of a combination of text and visual elements to aid hearing impaired patients. This allows the patients to better understand, identify, and/or conceptualize audio information, and substitute incommunicable audio information with communicable visual information.

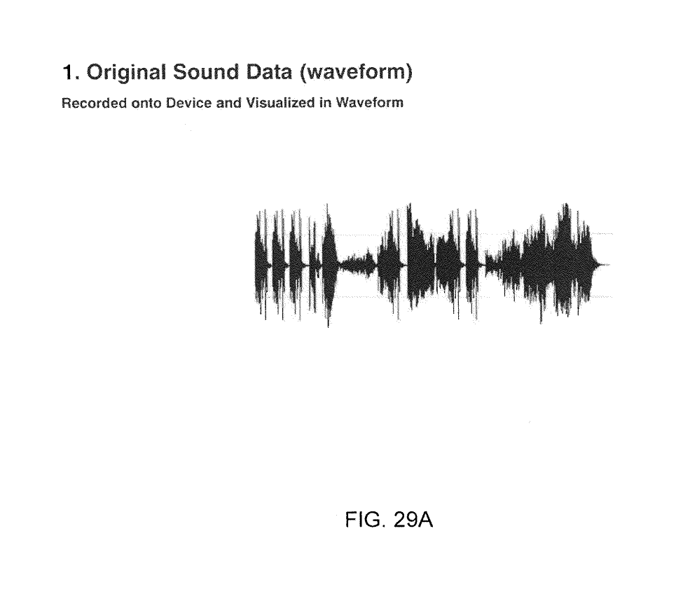

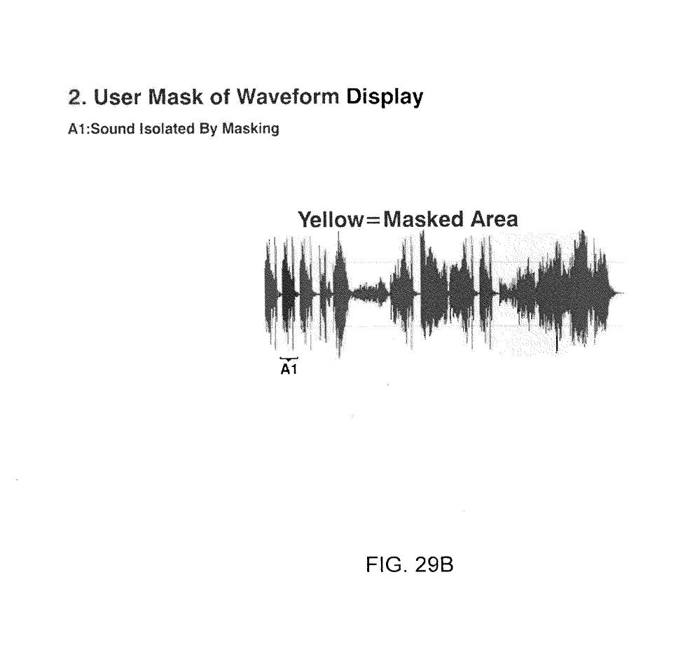

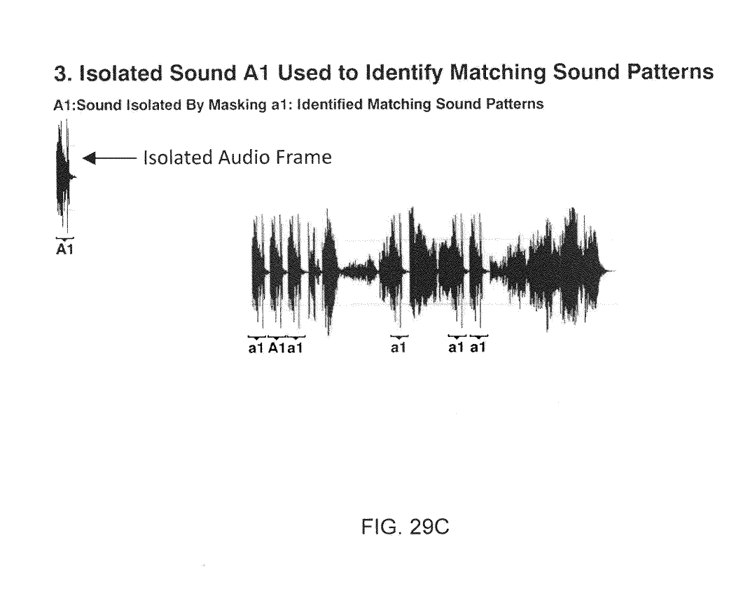

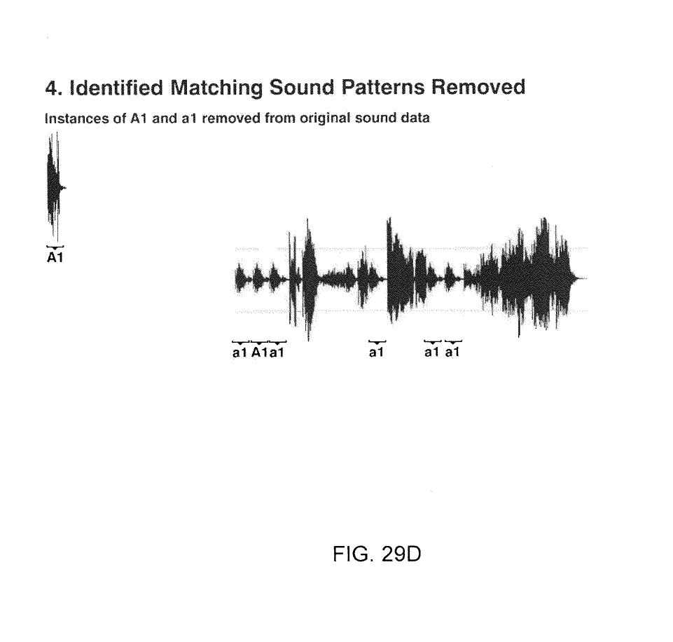

In embodiments, systems and methods of the disclosed subject matter can use masking techniques to isolate specific sound patterns in audio information. FIGS. 29A-29D illustrate a process of isolating specific sound patterns in accordance with embodiments of the present invention. FIG. 29A shows a pitch profile of audio information in a time domain. A user can use this visualization of the audio information to isolate sound frames of interest. FIG. 29B illustrates the user-interactive isolation of a sound frame. The user can mask sound frames that are not of interest to the user, which amounts to selecting an audio frame that is not masked out. In FIG. 29B, the user has effectively selected an audio frame labeled A1.

The selected audio frame can be isolated from the audio information. The isolated audio frame is illustrated in FIG. 29C. The isolated audio frame can be played independently from the original audio information. Once the user isolates an audio frame, the original audio information can be further processed to identify other audio frames having a similar profile as the isolated audio frame. In embodiments, audio frames having similar a profile as the isolated audio frame can be identified by correlating the original audio information and the isolated audio frame. FIG. 29C illustrates that audio frames similar to the isolated audio frame “A1” appears five more times in the original audio information, identified as “al.”

In embodiments, the identified audio frames can be further processed to modify the characteristics of the original audio information. For example, the identified audio frames can be depressed in magnitude within the original audio information so that the identified audio frames are not audible in the modified audio information. The identified audio frames can be depressed in magnitude by multiplying the original audio frames with a gain factor less than one. FIG. 29D illustrates a modification of the audio information that depresses the magnitude of the identified audio frames. Non-limiting examples for using the audio information modification mechanism can include filtering the isolated sound patterns or corresponding audio data from the original audio file or other audio input.

In embodiments, the KasahComm application can aid mentally disabled people. It is generally known that mentally disabled people suffering from various neurological disorders, such as autism spectrum disorder (ASD) and attention deficit hyperactivity disorder (ADHD), fail to communicate effectively with other people. As the intelligence of these patients is not entirely disrupted, the KasahComm application would be a good device to compensate for the defective communication skills. The KasahComm application allows elaborated communication because a picture speaks more than a thousand words. A photo per se will remarkably help for these mentally disabled people to express their thoughts and feelings by a few words or drawings associated with the photo to deliver as a method of communication. Moreover, although these people fail to communicate with eye contacts, they do not resist playing with computer-operated devices, including computer-gaming gadgets and digital cameras.

In embodiments, the KasahComm application may create a password protected image file. Some image display applications, such as windows photo viewer, can restrict access to images using a security feature. The security feature of the applications can request a user to provide a password before the user can access and view images. However, the security feature of image display applications is a part of the applications and is independent of the images. Therefore, users may by-pass the security feature of the applications to access protected images by using other applications that do not support the security feature.

For example, in some cases, access to a phone is restricted by a smartphone lock screen. Therefore, a user needs to “unlock” the smartphone before the user can access images on the phone. However, the user may by-pass the lock screen using methods such as syncing the phone to a computer or by accessing the memory card directly using a computer. As another example, in some cases, access to folders may be password protected. Thus, in order to access files in the folder, a user may need to provide password. However, the password security mechanism protects only the folder and not the files within the folder. Thus, if the user uses another software to access the contents of the folder, the user can access any files in the folder, including images files, without any security protections.

To address these issues, in embodiments, the KasahComm application may create a password protected image file by packaging a password associated with the image file in the same image container. By placing a security mechanism on the image file itself, the image file can remain secure even if the security of the operating system and/or the file system are breached.

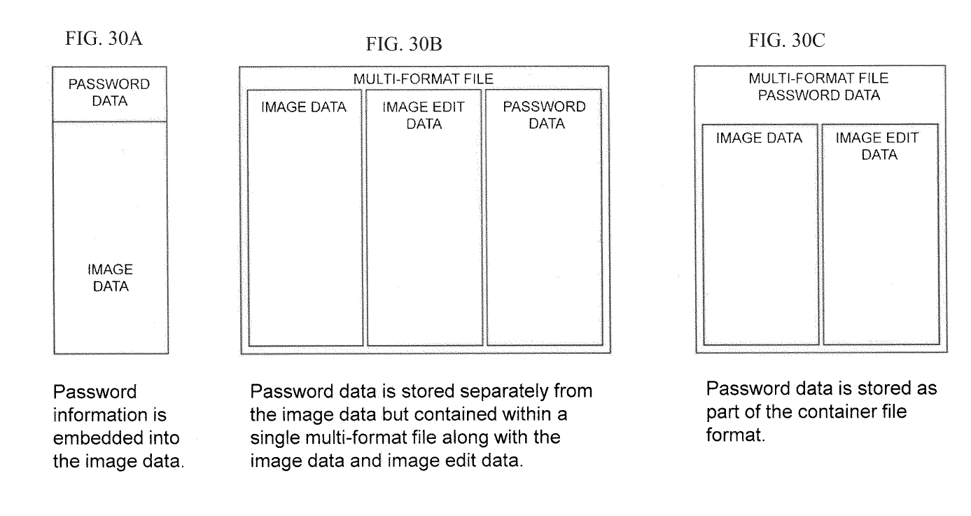

FIGS. 30A-30C illustrate an image representation that includes both the image file and the password in accordance with embodiments of the present invention. In some cases, as illustrated in FIG. 30A, the password data can be embedded into the image data itself. In other cases, as illustrated in FIG. 30B, the password data can be packaged in the same image container as the image data. In some other cases, as illustrated in FIG. 30C, the password data can be packaged in the header of the image container. In some cases, the password may be encrypted.

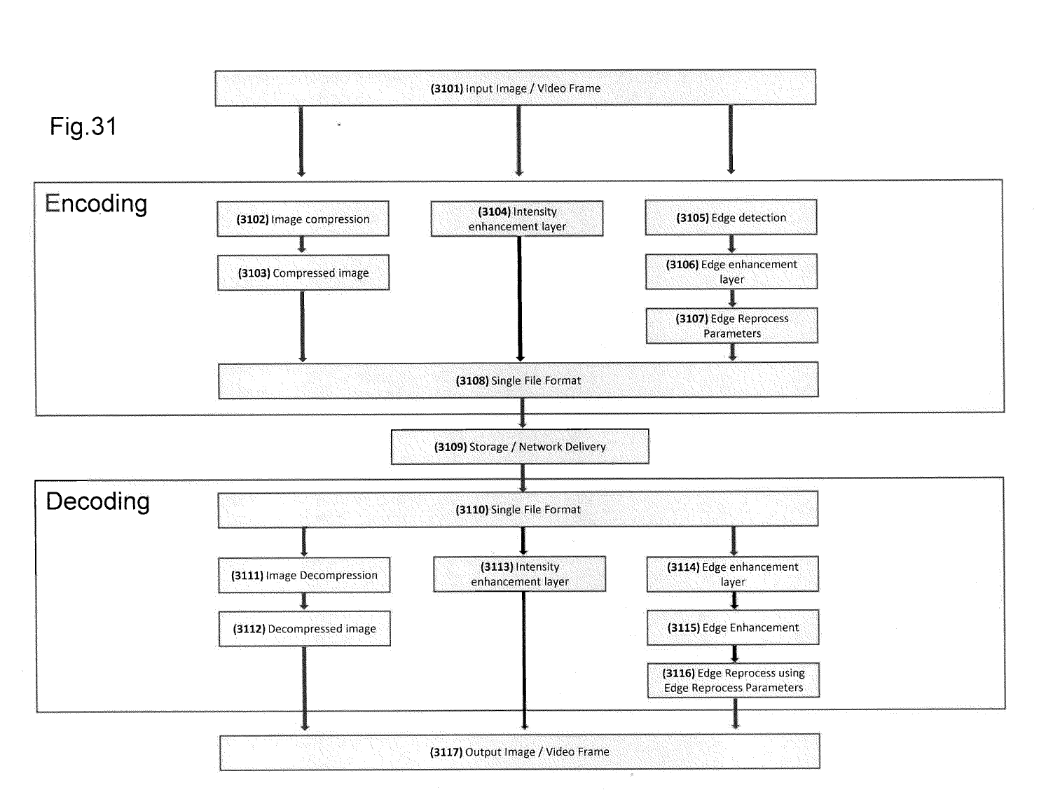

FIG. 31 illustrates encoding and decoding of an input image or a video frame. In some embodiments, three procedures can be performed in parallel during encoding and decoding of an input image or a video frame.

In some embodiments, the first step involves receiving an input image or video frame 3101. An input image can be any digital image or a single frame from video data. This can include streamed, live, or prerecorded data.

In some embodiments, once the input image is received, the input image can be processed through three parallel encoding procedures. In some embodiments, the first of the three parallel encoding procedures involves compressing the image 3102. The image compression can be done through a blurring function or down-sampling. The result of the image compression step 3102 can be a compressed image of the input image or video frame 3103.

In some embodiments, the second of the three parallel encoding procedures involves creating an intensity enhancement layer 3104. As edge information can be determined by changes in intensity, visually represented by highlights and shadows between neighboring pixels, an intensity enhancement layer can be created using known processes such as, but not limited to, extracting the Y component in the YCbCr space.

In some embodiments, the third of the three parallel encoding procedures involves edge detection 3105. Edge detection utilizing methods such as, but not limited to, Canny edge detection or other first-order methods, can be performed on the input image or video frame. After edge detection, bitmap information indicating the detected edge area can be saved as an edge enhancement layer 3106. The edge enhancement layer can be created by subtracting the non-edge data from the original image or video frame. After the creation of the edge enhancement layer, edge reprocess parameters can be saved 3107. The edge process parameters indicate the pixel radius which can define the area surrounding a pixel in the edge enhancement layer that will be reprocessed during decoding. The edge reprocess parameters can be created by utilizing special color different metrics and intensity information.

In some embodiments, the next step can involve combining into a single encoded file format 3108 the following from the three parallel encoding procedures: the compressed input image or video frame 3103, the intensity enhancement layer 3104, the edge enhancement layer 3106, and the edge process parameters 3107.

In some embodiments, the single encoded file format 3108 can be saved onto a storage device or delivered through existing networks 3109.

In some embodiments, the next step involves processing, in a decoding stage, the single file format in three parallel procedures 3110. In some embodiments, the first of the three parallel decoding procedures involves decompressing the image 3111. The image decompression can be completed by reversing the blurring function or down-sampling performed in step 3102. The image decompression that occurs in step 3111 results in a decompressed image 3112.

In some embodiments, the second of the three parallel decoding procedures involves extracting an intensity enhancement layer 3113 from the single file format 3110.

In some embodiments, the third of the three parallel decoding procedures involves decoding the edge enhancement layer 3114. The decoded edge enhancement layer can then be overlaid on the decompressed image to perform edge enhancement 3115. Edge reprocessing 3116 can be performed in the pixels surrounding the edge pixels, as described in 3114, utilizing the edge reprocess parameters, as described in 3107.

In some embodiments, the final output image or video frame that is created 3117 can be a combination of 3112, 3113, 3115, and 3116.

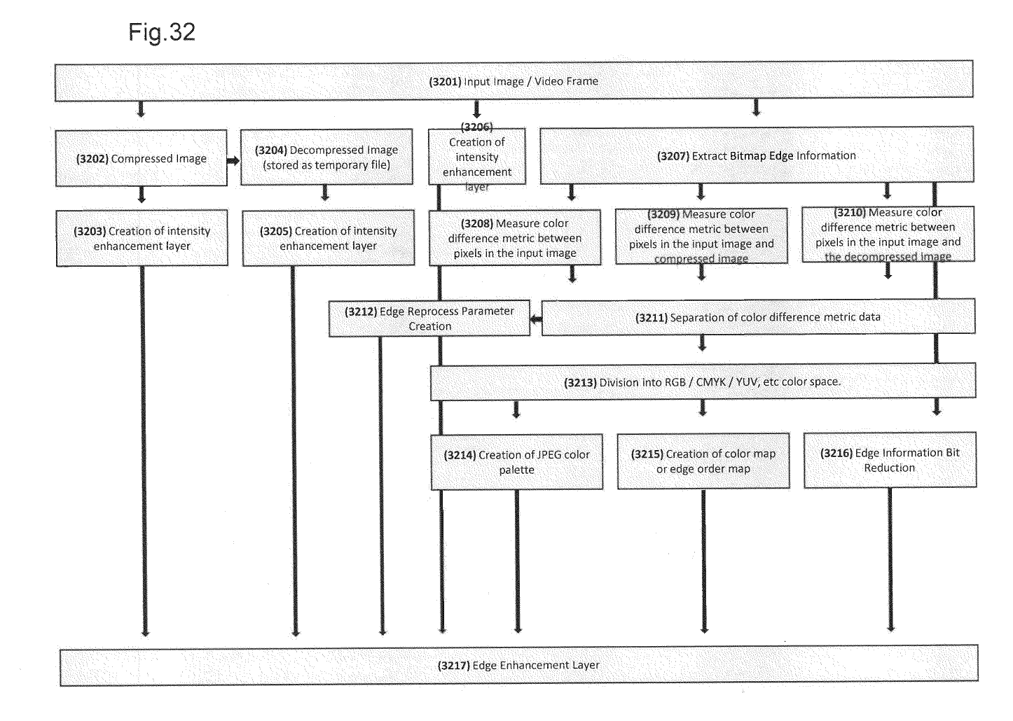

FIG. 32 illustrates a process of creating an edge enhancement layer in accordance with some embodiments.

In some embodiments, the first step involves receiving an input image or video frame 3201. An input image can be any digital image or a single frame from video data. This can include streamed, live, or prerecorded data.

In some embodiments, the edge enhancement layer can include three intensity enhancement layers. A first intensity enhancement layer 3203 can be created based on the pixels of a compressed image 3202. A second intensity enhancement layer 3205 can be created by based on a temporary file 3204, which can include a decompressed version of the compressed image in 3202. The second intensity enhancement layer 3205 can be created using known processes such as, but not limited to, extracting a luminescence from a color space, such as extracting the Y component in the YCbCr space from the image 3204. A third intensity enhancement layer 3206 can be created based on the input image/video frame pixel information 3201. The third intensity enhancement layer 3206 can be created using known processes such as, but not limited to, extracting the Y component in the YCbCr space from the image 3201.

In some embodiments, the edge enhancement layer can also include extracted bitmap edge information 3207. The bitmap edge information 3207 can be processed to measure the color difference metric between adjoining pixels in the input image 3208, measure the color difference metric between pixels in the input image and compressed image 3209, and measure the color difference metric between pixels in the input image and decompressed image 3210. All color difference metrics can be measured using known methods that can include, but not limited to, CIE94, CIEDE2000, and CMC I:c. The color difference metric information gathered in 3208, 3209, and 3210 can be separated into separate color spaces 3211.

In some embodiments, the resulting color different metric data 3211 can then be derivative metric data divided into sub pixel information separating the difference metric data into independent color information such as RGB/CMYK/YUV color spaces 3213. The quantity of data files in step 3213 can be dependent on the color space utilized, where RGB could result in 3 files where CMYK could result in 4.

In some embodiments, the resulting color different metric data can also be used to establish edge reprocess parameters 3212. The edge reprocess parameters can be based on the combination of 3208, 3209, 3210 and 3203, 3205, 3206.

In some embodiments, a JPEG color palette can be created to include all the colors existing in the extracted edge information area 3214. A JPEG color palette can be created where each pixel represents color information that exists in the extracted bitmap edge information 3207. The method of arrangement can be dependent of the order in which the edge bitmap is coded or grouped by similar colors using a color difference metric, initially created as a bitmap file then re-encoded as a JPEG file for data savings.

In some embodiments, a color or edge order map can be created to indicate which pixels in the edge information correspond to what color 3215. Creation of a color map or edge map can depend on the method in which the JPEG color palette is created. A color map could indicate what color in 3214 corresponds to what pixel utilizing a data array containing a XY coordinate system, whereas an edge order map could identify each color in 3214 with a specific numerical identifier indicating which pixel in the edge bitmap file it corresponds to.

In some embodiments, bit reduction 3216 can be performed on the bitmap edge information when color and spatial information lost in bit reduction is saved separately. Edge information bit reduction can be performed by lowering the bit rate of the edge information 3207 to any bit rate lower than the original input image or video frame 3201. This can be performed utilizing a weighted variable transform array, where each original spatial intensity metric data within a range of values is mapped to a value within the lower bit depth.

In some embodiments, the multiple intensity enhancement layers 3203 3205 3206, edge reprocess parameters 3212, JPEG color palette 3214, color or edge order map 3215, and bit reduced edge bitmap 3216 can be combined to make up the edge enhancement layer 3217.

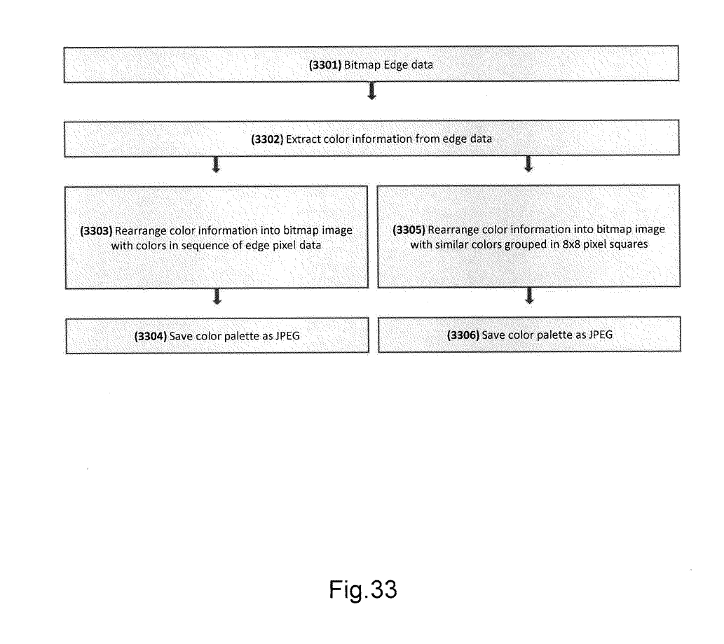

FIG. 33 illustrates a process of extracting color information from bitmap edge data in accordance with some embodiments.

In some embodiments, color information can be extracted from a bitmap edge data 3301 resulting in an data array of extracted color information specific to the edge area 3302, creating a color palette of the edge area. Color information can be extracted to create a bitmap file where each pixel represents a color that exists in the bitmap edge data 3301.

In some embodiments, the extracted color information can be rearranged into a bitmap image with the extracted colors arranged in sequential order determined by edge pixel data 3303. The resulting bitmap image can be saved as a JPEG file to induce compression of the color palette 3304. The bitmap file can be saved as a JPEG file for data savings.

In some embodiments, the extracted color information can be arranged with similar colors grouped in n by n pixel squares where n is any factor of 2 3305. Color grouping can be determined by processing the color difference metric data between the colors of the color palette. The resulting bitmap image can then be saved as a JPEG file to induce data compression 3306. The bitmap file can be saved as a JPEG file for data savings.

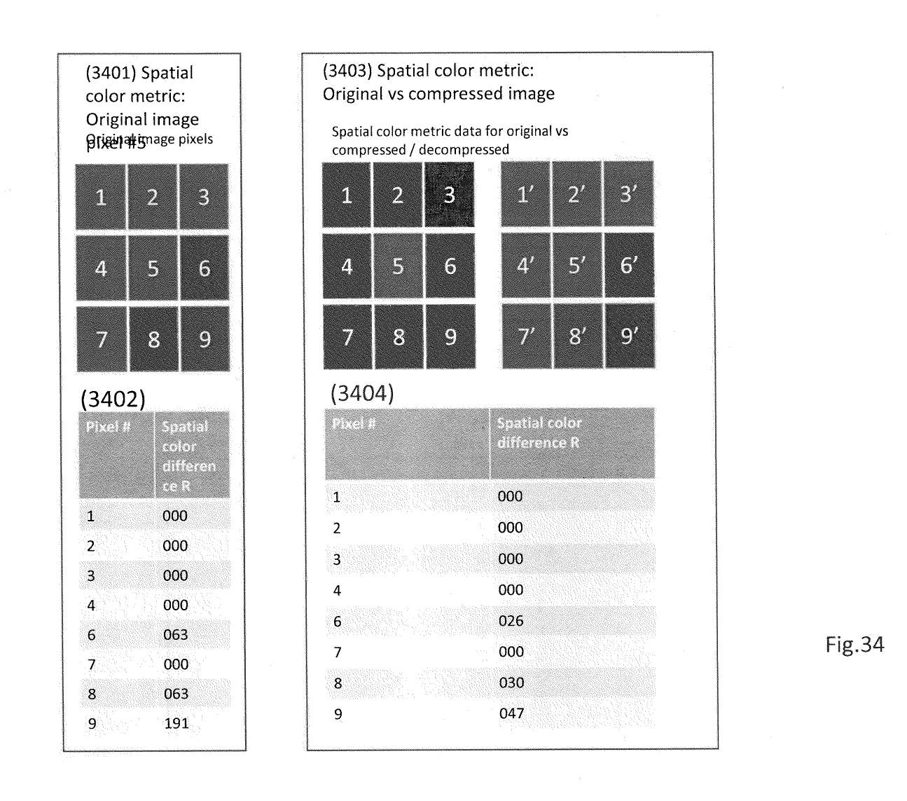

FIG. 34 illustrates measuring the color difference metric between pixels in accordance with some embodiments.

In some embodiments, spatial maps 3208 can be obtained by measuring the color difference metric between pixels in the input image 3401. Spatial maps 3209 can also be obtained by measuring the color difference metric between pixels in a compressed image or video frame created by the application of a blurring function or down-sampling, and the input image or video 3403. In 3403, a sample bitmap image file with 1, 2, 3 represents the original R channel color data of the input image and 1′, 2′, 3′ represents the R channel color data of the compressed or decompressed image. Spatial maps 3210 can also be obtained by measuring the color difference metric between pixels in a decompressed compressed image and the input image or video frame 3403.

In some embodiments, the spatial color difference metric information can be stored indicating a pixel number identifying the pixel and the spatial color difference 3402 3404. For example, 3402 represents the resulting data array mapping the spatial color difference of the R channel between pixel 5 and other pixels 1 through 9. In 3404, the chart represents the resulting data array from 3403 indicating the spatial color difference of the R channel when comparing pixel 1 to 1′ etc.

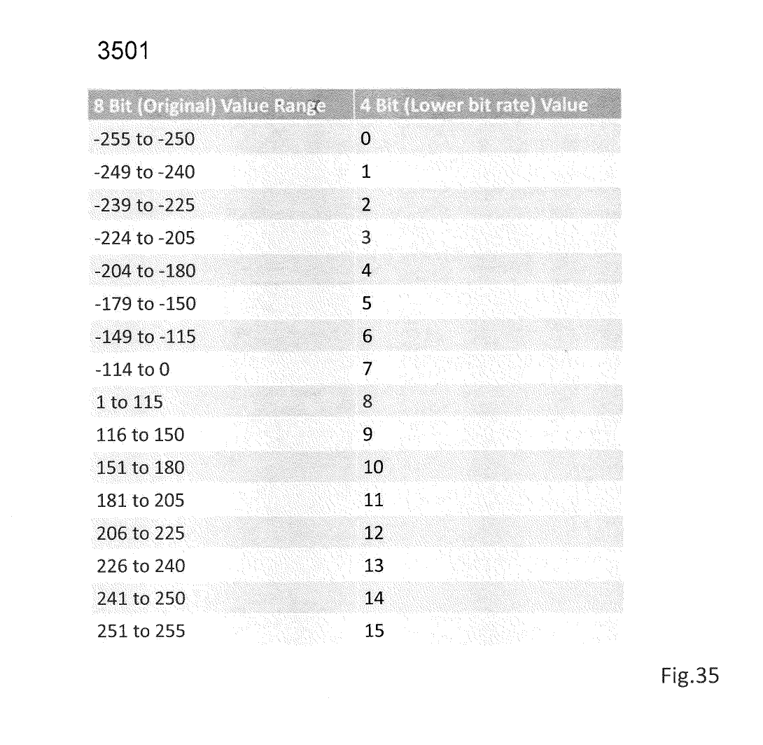

FIG. 35 illustrates a mapping of original spatial intensity metric data to values with lower bit depth in accordance with some embodiments. FIG. 35 illustrates a weighted edge information down-sampling data array where the left column indicates a weighted range of 8 bit color ranges, and the left column indicates the corresponding lower 4 bit rate color value.

In some embodiments, the spatial color difference metric difference data of the edge information can be down-sampled to a lower bit depth utilizing a weighted variable transform array, where each original spatial intensity metric data within a range of values is mapped to a value within the lower bit depth. The weighted system allows for varying ranges of color values to be mapped to a lower bit depth value so the mapping is not limited to a linear transcoding system. Values can be further defined in a palette table allowing for increased color representations while maintain the data saving properties of a lower bit depth. This down-sampling process can also be applied to intensity enhancement layers, such as in 3203, 3205, and 3206.

In some embodiments, this lower bit depth enhancement layer will require less data than the original higher bit enhancement layer creating less data overhead while achieving the desired results of edge enhancement.

In some embodiments, in order to achieve maximum edge reproduction from the lower bit depth enhancement, the edge reprocess parameters are also saved indicating the pixel radius, which can indicate the distance from the bit reduced edge pixels where reprocessing enhancement will occur, to create a smoother transition between the edge enhancement pixels and decompressed image. This distance information can be gained by processing the color difference metric data to indicate areas of highest color separation surrounding the bit reduced edge pixels.

In some embodiments, utilizing a maximum of three (3) intensity enhancement layers 3203 3205 3206 and three (3) sets of color difference metric data 3208 3209 3210 per color component, a subsequent and final lower bit depth enhancement layer can be created by combination and analysis of the multiple spatial intensity metric data to further isolate edge information. This can further enhance the edges of the compressed image during decompression without discernible image degradation or blurring function compression remnants.

In some embodiments, because the final lower bit depth enhancement layer is a simple bitstream, it can be further compressed using data compression algorithms such as DEFLATE. This final compressed lower bit depth enhancement layer containing spatial color and intensity metrics, can be stored with the blurring function and/or down-sampling compressed image or video in a single file format to be stored or delivered across a network.

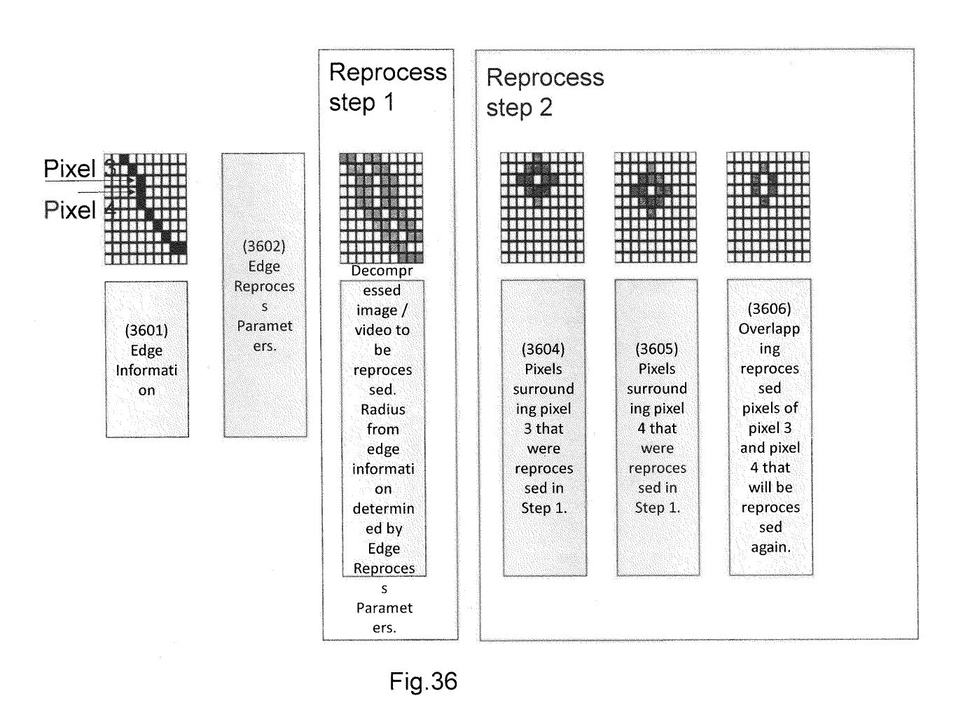

FIG. 36 illustrates reprocessing of edge information in accordance with some embodiments. The edge information 3601 processed in FIG. 36 can be a sample down-sampled original edge information such as 3501 in bitmap image form utilizing only 1 bit. In one embodiment, FIG. 36 illustrates the reprocessing of edge information with Pixels 3 and 4 in black and white only.

In some embodiments, reprocessing 3116 of the edge information 3601 during decoding is performed utilizing edge reprocess parameters 3602. The edge process parameters 3602 can be those described in 3212.

In some embodiments, step one of the reprocessing process 3603 can be determining the area of pixels surrounding the edge bitmap information to be reprocessed by the edge reprocess parameter. In one embodiment of a first step of the edge reprocess, the grey area can represent the pixels that will be initially reprocessed based on the edge reprocess parameters 3063. As this first step is performed by processing all the pixels in the edge in parallel, a second reprocess step may be necessary.

In some embodiments, step two can involve identifying the pixels that were reprocessed in step 1 for a specific pixel. In one embodiment, 3604 illustrates the pixels that were reprocessed in 3063 for pixel 3 as indicated in 3601. In one embodiment, 3605 illustrates the pixels that were reprocessed in 3063 for pixel 4 as indicated in 3601.

In some embodiments, overlapping reprocessed pixels can then be identified and a second round of reprocessing can be performed 3606. In one embodiment, the overlapping processed pixels, in gray, can be identified by comparing the pixels in 3604 and 3605. Reprocessing can be performed by utilizing the spatial color difference metric data 3501, intensity enhancement layer data 3203 3205 3206, and spatial color difference metric data obtained by comparing adjoining pixel information between the edge enhancement layer 3114 and decompressed image 3112. In some embodiments, this same process can be utilized to provide parameters to enhance compressed texture images prior to being sent to 3D rendering engines.

In some embodiments, the spatial color difference metric data can be stored as an intermediate enhancement layer. This enhancement layer can be created from the total spatial area of the bit stream, or a preselected spatial area within the input image such edge related pixels obtained through existing edge detection processes, depending on the level of enhancement desired in the output stream. This enhancement layer can be divided into derivative enhancement layers divided into subpixel information separating the color difference metric data into RGB, CMYK or similar color space.

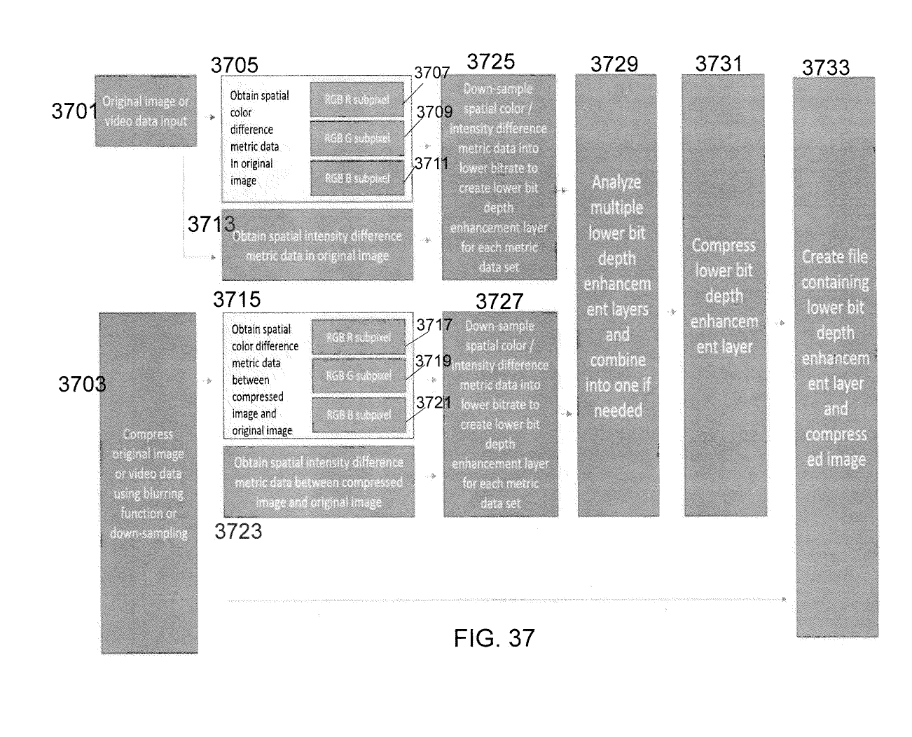

FIG. 37 illustrates a process of creating a file containing a lower bit depth enhancement layer and a compressed image, in accordance with some embodiments.

From the original image or video data input 3701, spatial color difference metric data in the original image is obtained 3705. The spatial color difference data can include RGB R subpixel 3707, RGB G subpixel 3709, and RGB B subpixel 3711. Spatial intensity difference metric data can also be obtained in the original image 3713. Referring to step 3725, spatial color/intensity difference metric data is down-sampled into a lower bitrate to create lower bit depth enhancement layer for each metric data set.

Referring to step 3703, the original image or video data input 3701 is also compressed using a blurring function or down-sampling. From the compressed image 3703, spatial color difference metric data between the compressed image and the original image is obtained 3715. The spatial color difference data can include RGB R subpixel 3717, RGB G subpixel 3719, and RGB B subpixel 3721. Spatial intensity difference metric data between the compressed image and the original image can also be obtained 3723. Referring to step 3727, the spatial color and intensity difference metric data is down sampled into a lower bitrate to create a lower bitrate depth enhancement layer for each metric data set.

The multiple bit depth enhancement layers are analyzed and combined into one if needed 3729. The lower bit depth enhancement layer is then compressed 3731. Referring to step 3733, a file is created containing lower bit depth enhancement layer and compressed image.

In some embodiments, when deconvolution of the compressed image or video is performed utilizing methods to reverse blurring function or down-sampling, decompression of the lower bit enhancement layer can be performed utilizing a DEFLATE or similar decoder. Edge enhancement can then performed by utilizing the color and/or intensity difference metric stored in the lower bit enhancement layer to recalculate the color and intensity of the decompressed base layer image or video.

The same lower bit enhancement layer can be utilized to provide parameters to enhance compressed texture images prior to being sent to 3D rendering engines.

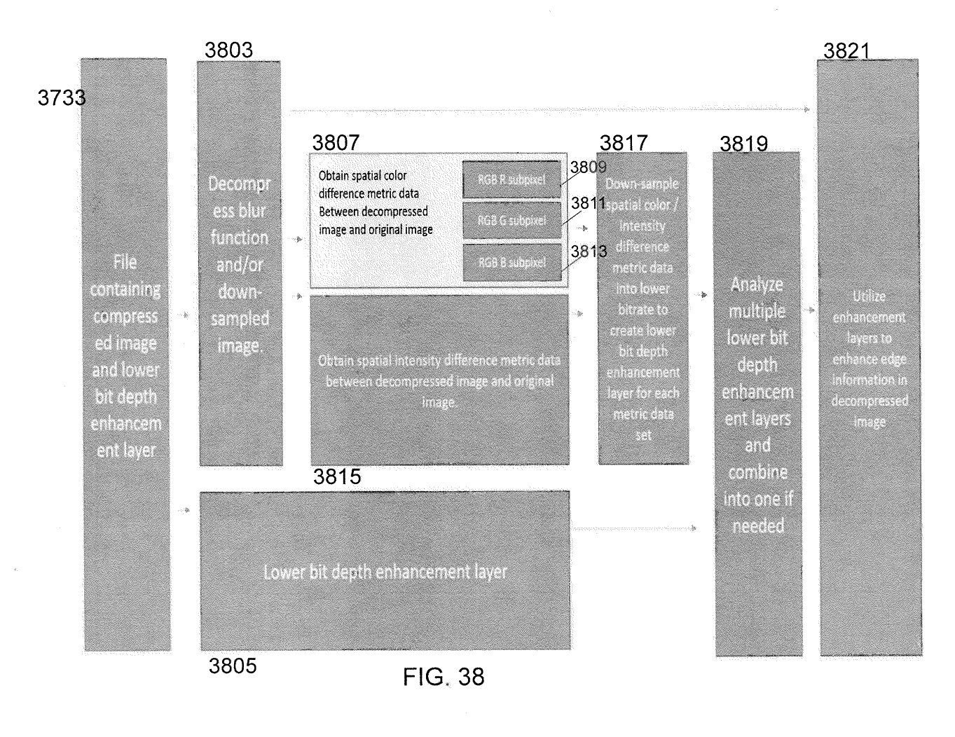

FIG. 38 illustrates a process of utilizing enhancement layers to enhance edge information in a decompressed image, in accordance with some embodiments.

From a file containing compressed image and lower bit depth enhancement layer 3733, blur function and/or down-sampled image is decompressed 3803. Spatial color difference metric data between decompressed image and original image is obtained 3807. The spatial color difference metric data can include RGB R subpixel 3809, RGB G subpixel 3811, or RBG B subpixel 3813. Spatial intensity difference metric data between decompressed image and original image can also be obtained 3815. Referring to step 3817, spatial color/intensity difference metric data is down-sampled into a lower bitrate to create lower bit depth enhancement layer for each metric data set 3817. Multiple lower bit depth enhancement layers 3817 3805 are analyzed and combined into one multiple lower bit depth enhancement layer, if needed 3819. Referring to step 3821, enhancement layers are utilized to enhance edge information in the decompressed image.

The availability of professional and consumer digital image capture devices, the quantity of images stored on one device such as a personal computer have increased dramatically. Coupled with the popularity of file sharing technologies such as cloud based file sharing and messaging software, there is a higher possibility that duplicate image files exist on multiple computers.

As images can be categorized into several independent types dependent on subject matter, such as “a photo of a mountain” or “a photo of a building” it can be assumed that there exists a distinct similarity across multiple images even if the image is of two distinct and separate subject matters such as Mt. Fuji and Mt. Ararat, but because both subject matters are mountains, the two images can be noted as discernibly similar.

Extending this concept to multiple images where instead of stating that two images are similar based on the entire image frame, but to smaller blocks within the two images that may or may not be located in the same corresponding coordinates, and then increasing the block based similarity comparison to a multitude of images, it is possible that an original single image can be recreated to a level of high similarity utilizing image data blocks from a multitude of preexisting images.

Utilizing data differencing between the original image and the recreated image, the data needed to be transmitted from the original image data source to the recipient can be minimized beyond the image compression possibilities of methods that utilize inter frame compression as our invention is not limited to a Group of Pictures structure or any temporal structure, and can perform spatial block referencing from multiple images across multiple data files.

The process needs only to be reversed to recreate the original image from the difference data and image reference data.

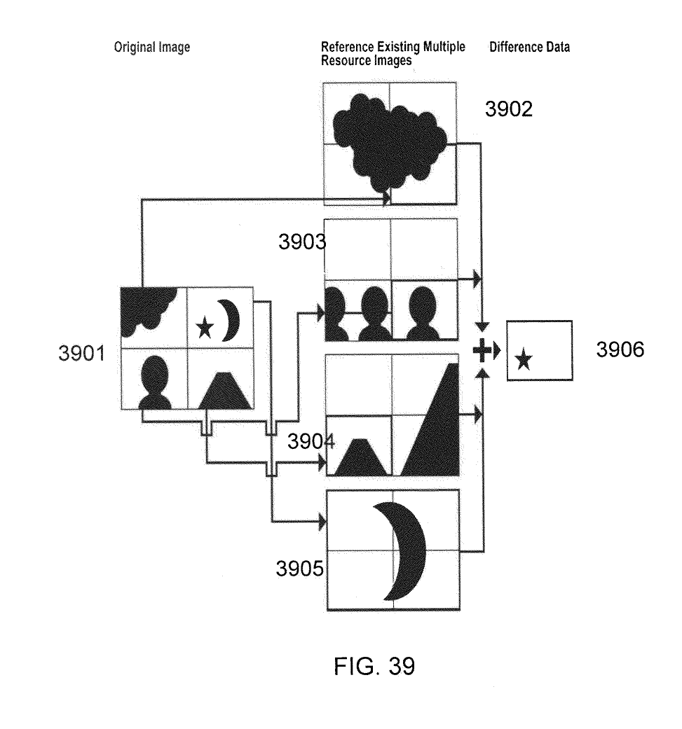

FIG. 39 illustrates a process of utilizing resource images to determine difference data in an original image, in accordance with some embodiments.

An original image 3901 is separated into macroblocks which are processed using methods such as Block Matching Algorithms utilized in inter frame prediction to find a reference frame from existing image files 3902 3903 3904 3905 and discover spatial redundancies. Macroblocks can be the size of the entire image, or a subset of the entire image, such as rectangular blocks, arbitrarily shaped patches determined by the system, or in its smallest instance, a single pixel. In some embodiments, image matching algorithms and subset matching methodologies such as shape, object, pattern and facial recognition may be used to initially categorize existing images into sets to decrease the computation required to determine motion estimation and motion compensation with the least amount of prediction error. Search parameters for macro-block matching can be adjusted to further adjust the computation requirements of block matching. A motion vector is also obtained pointing to the matched block in the referenced image, allowing for the motion estimation and motion compensation.

Multiple blocks can be combined and downsampled into a single block to be utilized as a reference frame. Other forms of block manipulation using predetermined filters such as rotation and translation in three dimensions, zoom and blur amongst other known image manipulation filters can also be used. The combination of such methodology can provide an approximation of the motion of the spatial redundant image objects and the difference data 3906 between the original image and the approximation resulting from block matching will be computed and stored as prediction error. This process of block matching and prediction error computation is repeated for each macroblock in the original image against all available images on the processing device.

Once the original image is processed on the original device utilizing the above methods, the complete difference data made up of the total prediction error and a listing of images used in block matching is stored locally to a dependent device such as a hard drive or transferred across a network to a separate independent device.

In some embodiments, it is assumed that all images are identically available on the target computer which will be able to reverse this process to recreate the original image by transferring only the prediction error data from the original device to the target device. Therefore significantly less data will need to be transferred in comparison to transferring all the data of the original image from the original device to the target device.

In embodiments, the KasahComm application can place a limit on how long an image file can be accessed, regardless of whether a user has provided a proper credential to access the image file. In particular, an image file can “expire” after a predetermined period of time to restrict circulation of the image file. An image may be configured so that it is not meant to be viewed after a specific date. For example, an image file associated with a beta test software should not be available for viewing once a retail version releases. Thus, the image can be configured to expire after the retail release date. In embodiments, the expiration date of the image can be maintained in the header field of the image container.

In embodiments, the KasahComm application may be used to provide communication between multiple and varying electronic devices over a secure private network utilizing independent data storage devices.

In embodiments, the KasahComm application may be used to provide messages, including images and text, to multiple users. The messages can be consolidated using time specific representations such as, but not limited to, a timeline format. In some cases, the timeline format can include a presentation format that arranges messages in a chronological order. In other cases, the timeline format can include a presentation format that arranges images and text as a function of time, but different from the chronological order. For example, messages can be arranged to group messages by topic. Suppose messages between to users, u, v, were chronologically ordered as follows: vA1, uA1, vB1, uA2, uA3, uB1, where u, v, indicates the user sending the message, A and B indicate a message group based on the topic, and the numbers indicate the order within the message group. For example:

vA1: Where are you now?

uA1: I'm still at home leaving soon!

vB1: Steve and James are already here. What did you want to do after dinner?

uA2: I'm getting dressed as we speak.

uA3: Should be there in 5 min.

uB1: Want to go see the new action movie?

Because u and v sent the message substantially simultaneously, vB1, which belongs to a different topic, is chronologically sandwiched between uA1 and uA2. This may confuse the users, especially when there are multiple users. Thus, the messages can be consolidated to group the messages by the message groups. After consolidation, the messages can be reordered as follows:

vA1: Where are you now?

uA1: I'm still at home leaving soon!

uA2: I'm getting dressed as we speak.

uA3: Should be there in 5 min.

vB1: Steve and James are already here. What did you want to do after dinner?

uB1: Want to go see the new action movie?

In embodiments, the messages can be consolidated at a server. In other embodiments, the messages can be consolidated at a computing device running the KasahComm application. In embodiments, messages that have been affected by reorganization due to message grouping may be visualized differently from messages that have not been affected by reorganization. For example, the reorganized messages can be indicated by visual keys such as, but not limited to, change in text color, text style, or message background color, to make the user aware that such reordering has taken place.

In embodiments, the message group of a message can be determined by utilizing one or more of the following aspects. In one aspect, the message group of a message can be determined by receiving the message group designation from a user. In some cases, the user can indicate the message group of a message by manually providing a message group identification code. The message group identification code can include one or more characters or numerals that is associated with a message group. In the foregoing example, messages were associated with message groups A and B. Thus, if a user sends a message—“A Should be there in 5 min”—where “A” is the message group identification code, this message can be associated with the message group A. In other cases, the user can indicate the message group of a message by identifying the message to which the user wants to respond. For example, before responding to “Where are you now?”, the user can identify that the user is responding to that message and type “I'm still at home leaving soon!”. This way, the two message, “Where are you now?” and “I'm still at home leaving soon!” can be associated with the same message group, which is designated as the message group A. The user can identify the message to which the user wants to respond by a finger tap, mouse click or other user input mechanism for the KasahComm application (or the computing device running the KasahComm application.)

In one aspect, the message group of a message can be determined automatically by using a timestamp indicative of the time at which a user of a KasahComm application begins to compose the message. In some cases, such timestamp can be retrieved from a computing device running the KasahComm application, a computing device that receives the message sent by the KasahComm application, or, if any, an intermediary server that receives the message sent by the KasahComm application.

As an example, suppose that (1) a first KasahComm application receives the message vA1 at time “a”, (2) a user of the first KasahComm application begins to compose uA1 at time “b”, (3) the first KasahComm application sends uA1 to a second KasahComm application at time “c”, (4) the user of the first KasahComm application begins to compose uA2 at time “d”, (5) the first KasahComm application receives the message vB1 at time “e”, and (6) the first KasahComm application sends uA2 to the second KasahComm application at time “f”.

In some cases, when displaying messages for the first KasahComm application, messages can be ordered based on the time at which messages are received by the first KasahComm application and at which the user of the first KasahComm application began to compose the messages. This way, the order of the messages becomes vA1(a), uA1(b), uA2(d), vB1(e), which properly groups the messages according to the topic. This is in contrast to cases in which messages are ordered based on the time at which messages are “received” or “sent” by the first KasahComm application, because under this ordering scheme, the order of the messages becomes vA1(a), uA1(c), vB1(e), uA2(f), which does not properly group the messages according to the topic.

In other cases, messages can be automatically grouped based on a time overlap between (1) a receipt of a message from the second KasahComm application and a predetermined time period thereafter and (2) the time at which the user of the first KasahComm application begins to compose messages. In these cases, from the first KasahComm application's perspective, a received message can be associated with the same message group as messages that began to be composed between the receipt of the message and a predetermined time period thereafter. For example, if the user of the first KasahComm application begins to compose messages between time “a” and “f”, those messages would be designated as the same message group as the message received at time “a.” The predetermined time period can be determined automatically, or can be set by the user.

In embodiments, the KasahComm application may be used to provide off-line messaging functionality.

In embodiments, the KasahComm application may include geotagging functionality. In some cases, the location information can be provided through Global Positioning System (GPS) and geographical identification devices and technologies. In other cases, the location information can be provided from a cellular network operator or a wireless router. Such geographical location data can be cross referenced with a database to provide, to user, map information such as city, state and country names and may be displayed within the communication content.

In embodiments, the KasahComm application can provide an emergency messaging scheme using the emergency contacts. Oftentimes, users do not turn on location services that use location information for privacy reasons. For example, users are reluctant to turn on a tracking system that tracks location of the mobile device because users do not want to be tracked. However, in emergency situations, the user's location may be critically important. Therefore, in emergency situations, the KasahComm application can override the location information setting of the mobile device and send the location information of the mobile device to one or more emergency contacts, regardless of whether the location information setting allows the mobile device to do so.

To this end, in response to detecting an emergency situation, the KasahComm application can identify an emergency contact to be contacted for emergency situations and purposes. The KasahComm application can then override the location information setting with a predetermined location information configuration, which enables the KasahComm application to provide location information to one or more emergency contacts. Subsequently, the KasahComm application can send an electronic message over the communications network to the one or more emergency contacts. The predetermined location information configuration can enable the mobile device to send the location information of the mobile device. The location information can include GPS coordinates. The electronic message can include texts, images, voices, or any other types of media.

In embodiments, the emergency situations can include situations involving one or more of fire, robbery, battery, weapons including guns and knives, and any other life-threatening circumstances. In some cases, the KasahComm application can associate one of these life-threatening circumstances with a particular emergency contact. For example, the KasahComm application can associate emergency situations involving fire with a fire station.

In embodiments, the KasahComm application may utilize the location information to present images in non-traditional formats such as the presentation of images layered on top of geographical maps or architectural blueprints.

In embodiments, the KasahComm application may utilize the location information to create 3D representations from the combination of multiple images.

In embodiments, the KasahComm application may create a system that calculates the geographical distance between images based on the location information associated with the images. The location information associated with the images can be retrieved from the images' metadata.

In embodiments, the KasahComm application can utilize the location information to provide weather condition and temperature information at the user's location.

In embodiments, the KasahComm application can utilize the location information and other technologies, such as built in gyroscope and accelerometers, to create user created images and/or modified to be displayed on a communication recipients device when the recipient is in proximity of the location where the image was created.

In embodiments, the KasahComm application can retrieve device specific information associated image data to identify the original imaging hardware such as, but not limited to, digital cameras to be delivered with the images and present such information within the KasahComm application. Such information can be utilized to confirm authenticity of the image source, ownership of used hardware, or simply be provided for general knowledge purposes.

In embodiments, the KasahComm application can network images captured on digital cameras to application software located on a networked computer or mobile device to be prepared for automatic or semi-automatic delivery to designated users on private or public networks.

In embodiments, systems and methods of the disclosed subject matter may be incorporated or integrated into electronic imaging hardware such as, but not limited to, digital cameras for distribution of images across communication networks to specified recipients, image sharing, or social networking websites and applications. Such incorporation would forgo the necessity for added user interaction and drastically automate the file transmission process.

In embodiments, the KasahComm application can include an image based security system. The image based security system uses an image to provide access to the security system. The access to the security system may provide password protected privileges, which can include access to secure data, access to systems such as cloud based applications, or a specific automated response which may act as a confirmation system.

In some cases, the image based security system can be based on an image received by the image based security system. For example, if a password of the security system is a word “A”, one may take a photograph of a word “A” and provide the photograph to the security system to gain access to the security system.

In some cases, the image based security system can be based on components within an image. For example, if a password of the security system is a word “A”, one may take a photograph of a word “A”, provide a modification to the photograph based on the security system's specification, which is represented as an overlay layer of the photograph, and provide the modified photograph to the security system. In some cases, the security system may specify that the modified photograph should include an image of “A” and a signature drawn on top of the image as an overlay layer. In those cases, the combination of the “signature” and the image of “A” would operate as a password to gain access to the security system.

In some cases, the image based security system can be based on modifications to an image in which the image and the modifications are flattened to form a single image file. For example, if a password of the security system is a word “A”, one may take a photograph of a word “A”, provide a modification to the photograph based on the security system's specification, flatten the photograph and the modification to form a single image, and provide the flattened image to the security system. In some cases, the security system may specify that the flattened image should include an image of “A” and a watermark on top of the photograph. The watermark may serve to guarantee that the photograph of “A” was taken with a specific predetermined imaging device and not from a non-authorized imaging device and therefore function as a password.

The access to the security system may provide password protected privileges, which can include access to secure data, access to systems such as cloud based applications, or a specific automated response which may act as a confirmation system.

In embodiments, systems and methods of the disclosed subject matter may be used to trigger an automatic response from the receiver of the transferred data file, and vice versa. The automated response may be dependent or independent on the content of the data file sent to the recipient.

In embodiments, systems and methods of the disclosed subject matter may be used to trigger remote distribution of the transferred data file from the sender to the receiver to be further distributed to multiple receivers.

In embodiments, systems and methods of the disclosed subject matter may be used to scan bar code and QR code information that exists within other digital images created or received by the user. The data drawn from the bar code or QR code can be displayed directly within the KasahComm application or utilized to access data stored in other compatible applications.

In embodiments, systems and methods of the disclosed subject matter can perform digital zoom capabilities when capturing a photo with the built-in camera. When the built-in camera within the KasahComm application is activated, a one finger press on the screen will activate the zoom function. If the finger remains pressed against the screen, a box will appear designating the zoom area and the size of the box will decrease in size while the finger retains contact with the screen. Releasing the finger from the screen triggers the camera to capture a full size photo of the content visible within the zoom box.

In embodiments, systems and methods of the disclosed subject matter may use a camera detectable device in conjunction with the KasahComm application. A camera detectable device includes a device that can be identified from an image as a distinct entity. In some cases, the camera detectable device can emit a signal to be identified as a distinct entity. For example, the camera detectable device can include a high-powered light emitting device (LED) pen: the emitted light can be detected from an image.

When the camera detectable device is held in front of the camera, the camera application can detect and register the movement of the camera detectable device. In embodiments, the camera detectable device can be used to create a variation of “light painting” or “light art performance photography” for its creative applications. In other embodiments, the camera detectable device can operate to point to objects on the screen. For example, the camera detectable device can operate as a mouse that can operate on the objects on the screen. Other non-limiting detection methods of the camera detectable device can include movement based detection, visible color based detection, or non-visible color based detection such as through the usage of infrared. The KasahComm application of this functionality can include methods for navigating within the KasahComm application, for example, for browsing messages within the KasahComm application, or as an editing tool, for example, for editing images.

The KasahComm application can be implemented in software. The software needed for implementing the KasahComm application can include a high level procedural or an object-orientated language such as MATLAB®, C, C++, C#, Java, or Perl, or an assembly language. In embodiments, computer-operable instructions for the software can be stored on a non-transitory computer readable medium or device such as read-only memory (ROM), programmable-read-only memory (PROM), electrically erasable programmable-read-only memory (EEPROM), flash memory, or a magnetic disk that can be read by a general or special purpose-processing unit. The processors can include any microprocessor (single or multiple core), system on chip (SoC), microcontroller, digital signal processor (DSP), graphics processing unit (GPU), or any other integrated circuit capable of processing instructions such as an x86 microprocessor.

The KasahComm application can operate on various user equipment platforms. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, Apple iOS, RIM BlackBerry OS, Windows Mobile, Linux, HP WebOS, and Android. The interface screen may be a touch screen that is used to input data to the mobile device, in which case the screen can be used instead of the full keyboard. The user equipment can also keep global positioning coordinates, profile information, or other location information.

The user equipment can also include any platforms capable of computations and communication. Non-limiting examples can include televisions (TVs), video projectors, set-top boxes or set-top units, digital video recorders (DVR), computers, netbooks, laptops, and any other audio/visual equipment with computation capabilities.

In embodiments, the user can interact with the KasahComm application using a user interface. The user interface can include a keyboard, a touch screen, a trackball, a touch pad, and/or a mouse. The user interface may also include speakers and a display device. The user can use one or more user interfaces to interact with the KasahComm application. For example, the user can select a button by selecting the button visualized on a touchscreen. The user can also select the button by using a trackball as a mouse.

We claim:

1. A method of communicating image data over a communication network, the method comprising:
receiving, by a computing device, image data;
compressing the image data, by the computing device, using at least one of a blurring function and a down sampling function to form a compressed image;
generating, by the computing device, intensity data, the intensity data comprising differences in intensity between adjacent pixels in the image data;
generating, by the computing device, edge data, the edge data comprising a bitmap including data corresponding to edge information of the image data;
aggregating, by the computing device, the compressed image data, the intensity data and the edge data into a single encoded file; and
transmitting, by the computing device, the single encoded file over the communication network.

2. The method of claim 1, wherein the intensity data comprises at least three intensity data sets.

3. The method of claim 2, further comprising:
generating, by the computing device, a first intensity data set based on at least a portion of pixels of the compressed image;
generating, by the computing device, a second data set, wherein the method of creating the second intensity data set comprises:
decompressing, by the computing device, the compressed image data to form decompressed image data; and
extracting, by the computing device, a luminescence in a color space from the decompressed image data; and
generating, by the computing device, a third intensity data set based on at least a portion of pixels of the image data.

4. The method of claim 3, wherein the luminescence comprises a Y component, and the color space comprises a YCbCr space.

5. The method of claim 1, wherein the image data comprises a digital image.

6. The method of claim 1, wherein the image comprises a single frame from video data.

7. A method of communicating image data over a communication network, the method comprising:
receiving, by a computing device, image data;
identifying, by the computing device, at least one similarity macroblock in the image data, the at least one similarity macroblock having a level of similarity to at least one macroblock in reference image data;
identifying, by the computing device, difference data, the difference data comprising at least one macroblock in the image data having a level of difference from at least one macroblock in the reference image data;
generating, by the computing device, at least one motion vector corresponding to the reference image data, the at least one motion vector allowing for at least one of motion estimation and motion compensation between the at least one similarity macroblock in the image data and the at least one macroblock in the reference image data;
aggregating, by the computing device, the image data, the difference data, and the at least one motion vector into a single file;
compressing, by the computing device, the single file to form a single encoded file; and
transmitting, by the computing device, the single encoded file over the communication network.

8. The method of claim 7, wherein identifying the at least one similarity macroblock comprises processing, by the computing device, the image data using at least one block matching algorithm.

9. The method of claim 7, wherein the at least one similarity macroblock comprises at least one of the image data, a subset of the image data, and a single pixel of the image data.

10. The method of claim 9, wherein the subset of the image data comprises at least one of:
a portion of pixels forming at least one rectangular block, and
a portion of pixels forming at least one arbitrarily shaped patch.

11. The method of claim 7, wherein generating the at least one motion vector corresponding to the reference image data further comprises generating, by the computing device, multiple motion vectors corresponding to data in multiple reference images, the multiple motion vectors allowing for at least one of motion estimation and motion compensation between the multiple similarity macroblocks in the image data and the multiple macroblocks in the data corresponding to the multiple reference images.
